(19) United States
(12) Patent Application Publication
(10) Pub. No.: US 2026/0268916 A1
(43) Pub. Date: Sep. 10, 2026

(54) METHOD AND APPARATUS FOR SINUSOIDAL IDENTIFICATION FOR PACKET LOSS CONCEALMENT

(71) Applicant: Telefonaktiebolaget LM Ericsson (publ), Stockholm (SE)

(72) Inventors: Jonas SVEDBERG, Uppsala (SE); Martin SEHLSTEDT, Luleå (SE)

(21) Appl. No.: 19/491,279

(22) PCT Filed: Jun. 3, 2024
(86) PCT No.: PCT/EP2024/065146

§ 371 Date: Dec. 8, 2025

Related U.S. Application Data
(60) Provisional application No. 63/471,888, filed on Jun. 8, 2023.

(51) Int. Cl. G10L 19/012; G10L 19/005; G10L 19/02

(52) U.S. Cl. CPC G10L 19/012; G10L 19/005; G10L 19/02

(57) ABSTRACT

A method is provided to determine whether or not to mute valley bins in a frequency domain, FD, evolution step of a packet loss concealment in a phase error concealment unit in a decoder. The method includes obtaining an initial number of peaks, n_plocs, and peak locations, plocs, of the audio signal; if the number of peaks indicated by n_plocs is 1 or 2, performing, using the plocs, a non-pure sinusoidal analysis to determine whether or not the audio signal is a pure sinusoid; responsive to determining that the audio signal is not a pure sinusoid, not muting the valley bins in the FD evolution step; and responsive to determining that the audio signal is a pure sinusoid, muting the valley bins in the FD evolution step.

### TECHNICAL FIELD

The present disclosure relates generally to communications, and more particularly to encoding and decoding methods and related devices and nodes supporting encoding and decoding.

### BACKGROUND

Transmission of speech/audio over modern communications channels/networks is mainly done in the digital domain using a speech/audio codec. This involves taking the analog signal and digitalizing it using sampling and an analog to digital (A/D) converter (ADC) to get digital samples. These samples are further grouped into frames that contain samples from a consecutive period of 10-40 ms depending on the application. These frames are then processed using a compression algorithm and encoded to produce an encoded bit stream—this reduces the number of bits that needs to be transmitted and still achieve as high quality as possible. The encoded bit stream is then transmitted as data packets over the digital network to the receiver. In the receiver the process is reversed, the data packets are first decoded by a decoder to recreate the frame with digital samples which are then feed to a digital to analog (D/A) converter (DAC) to recreate the approximation of the input analog signal at the receiver. This is illustrated in FIG. 1.

When the data packets are transmitted over the digital network, there can be data packets that are either dropped by the network due to traffic load or bit errors can be introduced making the digital data invalid for decoding. When this happens, the decoder needs to replace the output signal during periods where it is impossible to do the actual decoding—this process is called packet loss concealment (PLC) and may be performed by an ECU (Error Concealment Unit). FIG. 2 illustrates an example of a decoder 200 having a PLC process. When a Bad Frame Indicator (BFI) indicates a lost or corrupted frame, PLC 202 may create a signal to replace the lost/corrupted frame. Otherwise, i.e., when BFI does not indicate lost or corrupted frame, the received signal is decoded by a stream decoder 204. A frame erasure may be signaled to the decoder by setting the bad frame indicator variable for the current frame active, i.e., BFI=1. The decoded or concealed frame is then input to DAC 206 to output an analog signal. Frame/packet loss concealment may also be referred to as error concealment unit (ECU).

There are numerous ways of doing PLC in the decoder. Some examples are; starting with the simplest, just to replace the lost frame with silence, slightly more advanced is to repeat the last frame (or decoding of the last frame parameters). Even more advanced solutions try to replace the frame with the most likely extrapolation of the signal. For noise like signals, one generates noise with a similar spectral structure. For tonal signals, one first estimates the characteristics of present tones (frequency, amplitude, and phase) and uses these parameters to generate a continuation of the tones at the corresponding temporal locations of lost frames.

One example of these more advanced ECUs is the Phase ECU, originally described in international patent application no. WO2014123469 where the decoder continuously saves a prototype of the decoded signal during normal decoding. This prototype is used in case of a lost frame and the prototype is spectrally analyzed, and one combines the noise and tonal ECU functions in the spectral domain. The Phase ECU identifies tones and calculates a spectral temporal replacement of related spectral bins, the other bins are handled as noise and are scrambled to avoid tonal artifacts in these spectral regions. The resulting recreated spectrum is inverse fast Fourier transform (IFFT) transformed into time domain and the signal is processed to create a replacement of the lost frame.

More information on how the Phase ECU PLC works can be found in international patent application no. WO2014123471.

### SUMMARY

There currently exist certain challenge(s). The LC3plus audio codec specification, ETSI IS 103634 v 1.4.1, uses a relatively crude measure to identify a single strong sinusoid in the whole audio spectra [e.g., from 0 hertz (Hz) to Fs/2 Hz]. The measure is simply that a full band bin-wise amplitude peak detector identifies one or two peaks within the absolute fast Fourier transform (FFT) spectra (for a 16 milliseconds (ms) analysis window of 768 bins at 48 kilohertz (kHz)). This method has been found to be insufficient when there is also a significant and perceptually important information in the valley noise envelope across the whole audio bandwidth. When this method detects a single strong sinusoid, the action taken is to not try to generate any other signal than the sinusoid itself, as the noise injection in the left low frequency “valley” and right high frequency “valley” may introduce unmasked noise distortion in relation to the pure tone.

Another legacy but rather computationally complex method is to use a frequency bin-wise tone-masking-noise analysis, for this legacy/historic method one would typically establish a slope of an approximate masking curve from the assumed single sinusoid peak, and then for every surrounding bin check if the peak sinusoids would mask the surrounding bins perceptually. A drawback with this method is that one has to find the amplitude of the true peak and perform the masking analysis.

Certain aspects of the disclosure and their embodiments may provide solutions to these or other challenges by introducing additional low-complex identification of pure single sinusoids.

In some embodiments, a method is provided to determine whether or not to mute valley bins in a frequency domain, FD, evolution step of a packet loss concealment in a phase error concealment unit in a decoder. The method includes obtaining an initial number of peaks, n_plocs, and peak locations, plocs, of the audio signal; if the number of peaks indicated by n_plocs is 1 or 2, performing, using the plocs, a non-pure sinusoidal analysis to determine whether or not the audio signal is a pure sinusoid; responsive to determining that the audio signal is not a pure sinusoid, not muting the valley bins in the FD evolution step; and responsive to determining that the audio signal is a pure sinusoid, muting the valley bins in the FD evolution step.

In some embodiments, there is provided a decoder that is adapted to determine whether or not to mute valley bins in a frequency domain, FD, evolution step of a packet loss concealment in a phase error concealment unit in the decoder. The decoder is adapted to obtain an initial number of peaks, n_plocs, and peak locations, plocs, of the audio signal; if the number of peaks indicated by n_plocs is 1 or 2, perform, using the plocs, a non-pure sinusoidal analysis to determine whether or not the audio signal is a pure sinusoid; responsive to determining that the audio signal is not a pure sinusoid, not mute the valley bins in the FD evolution step; and responsive to determining that the audio signal is a pure sinusoid, mute the valley bins in the FD evolution step

Certain embodiments may provide one or more of the following technical advantage(s). Various embodiments enable preserving high SNR (signal to noise ratio) generation of pure single sinusoids without adding DFT valley bin noise, when there is a truly single sinusoid present, without perceptually important information in valley regions. And when there is a single sinusoid with significant perceptual information in the low, high or both high and low frequency regions surrounding the sinusoid, those frequency regions will now correctly be generated including DFT valley bin noise injection. Various embodiments analyze differences/deltas that do not require an analysis of an absolute sound level.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 is a block diagram of audio transfer using an audio encoder and decoder over a network;

FIG. 2 is a block diagram of a decoder that includes packet loss concealment;

FIG. 3 is a block diagram illustrating a block diagram of a sinusoidal analysis and regeneration PLC, as performed by the Phase ECU method;

FIG. 4A is a plot showing the 16 ms 768 sample LC3plus Phase Ecu flat top hamming window;

FIG. 4 B is a plot showing a one-sided frequency response of the window of FIG. 4A;

FIG. 5A is a plot showing the 16 ms 768 sample LC3plus Phase Ecu flat top hamming window;

FIG. 5B is a plot showing the frequency response of the window of FIG. 5A;

FIG. 5C is a plot showing two different phase positions that may arise when using the window of FIG. 5A;

FIG. 6A is a plot showing an example 16 ms input signal with three added but frequency separated sinusoids (625 Hz, 2016 Hz, and 4031 Hz);

FIG. 6B is a plot showing the flat top hamming window and the windowed signal;

FIG. 6C is a plot showing the different frequency domain phase positions that may arise when analyzing the sinusoidal signal;

FIG. 7 is a stem signal plot illustrating a discrete Fourier transform (DFT) spectrum of a single sinusoid with subjectively significant background noise according to some embodiments;

FIG. 8 is a stem signal plot illustrating a DFT spectrum of a single sinusoid with subjectively significant background noise according to some embodiments;

FIG. 9 is a block diagram illustrating operations of a sinusoidal analysis and regeneration PLC with a sinusoidal peak and envelope analysis block according to some embodiments;

FIG. 10 is a flow chart illustrating the single sinusoid peak and noise envelope analysis according to some embodiments;

FIG. 11 is a magnitude vs. frequency plot illustrating example band split and grouping for the Xavg amplitude estimate according to some embodiments;

FIG. 12A is a plot showing an Absolute Hearing Threshold (ATH) curve and applied perceptual bands according to some embodiments;

FIG. 12B is a plot showing corresponding ATH derived weighting scalefactors at band borders according to some embodiments;

FIGS. 13-18 are flow charts illustrating operations of a decoder according to some embodiments;

FIG. 19 is a block diagram of an example of an operating environment for the various embodiments;

FIG. 20 is a block diagram of a decoder in accordance with some embodiments; and

FIG. 21 is a block diagram of a virtualization environment in accordance with some embodiments.

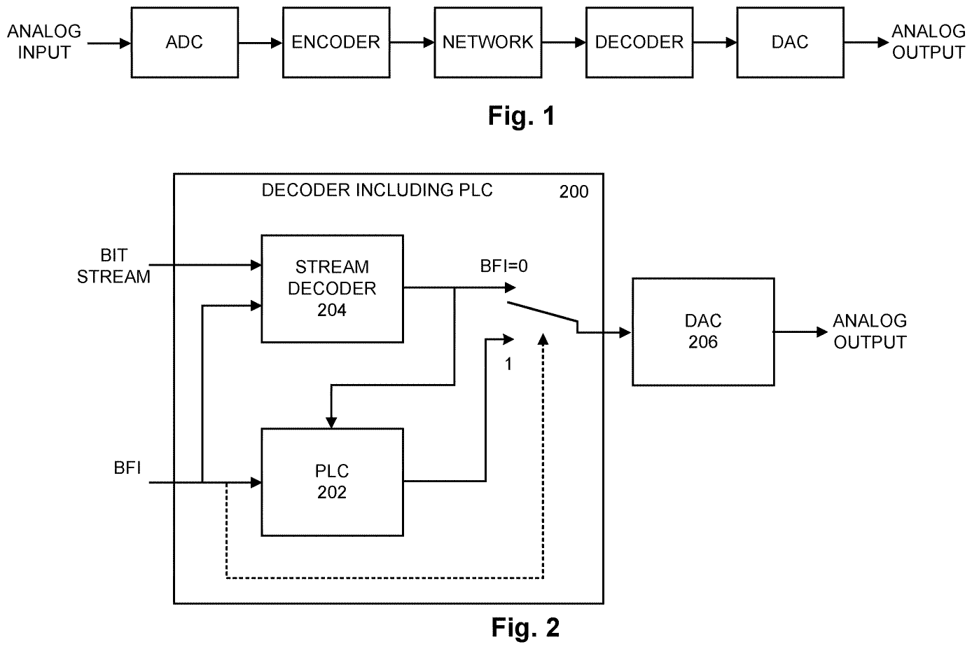

### DETAILED DESCRIPTION

Some of the embodiments contemplated herein will now be described more fully with reference to the accompanying drawings. Embodiments are provided by way of example to convey the scope of the subject matter to those skilled in the art, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

The term “transmit” is used herein to refer to an operation by a decoder, encoder, device, node, etc. to transmit through a transmitter circuit-to-air interface or to transmit through a network interface to cause another encoder, decoder, device, node, etc. to transmit through a transmitter circuit-to-air interface. Similarly, the term “receive” is used herein to refer to an operation by an encoder, decoder, device, node, etc. to receive through an air-to-receiver circuit interface or to receive through a network interface from another encoder, decoder, device, node, etc. that receives through an air-to-receiver circuit interface.

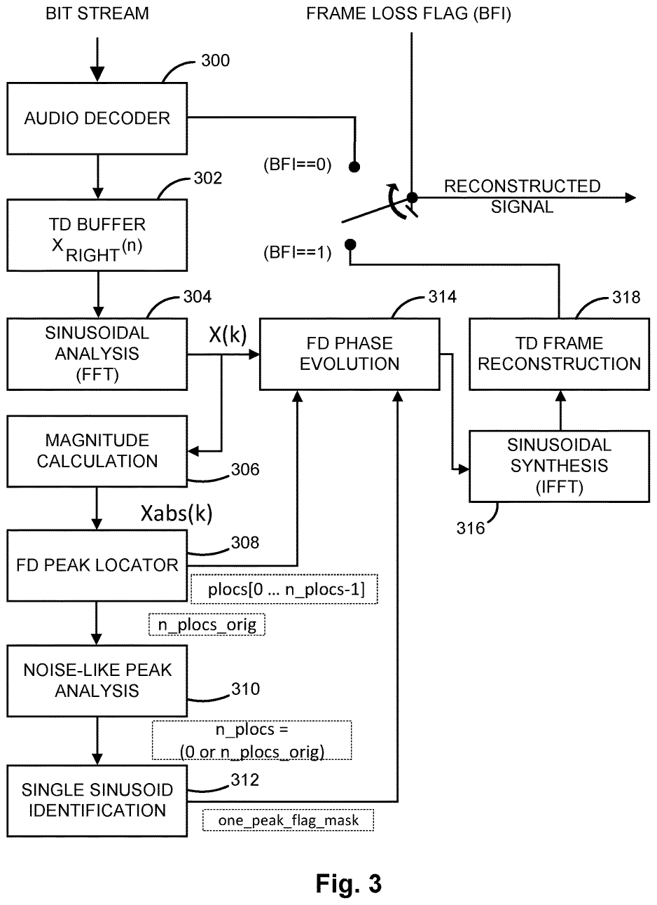

FIG. 3 illustrates a block diagram of a sinusoidal analysis and regeneration PLC as performed by the Phase ECU method that may be used for both speech signals and general audio signals. It operates by performing a time evolution of the decoder side decoded signal in the frequency domain. The concealment technique assumes that the lost frame can be represented by a limited number of sinusoidal components that are identified from a time domain signal buffer 302, x_{right}[n]. The identified sinusoidal components are time evolved to replace the lost frame, the calculated time domain frame substitute may then be processed using the MDCT-related TDA and ITDA steps, to facilitate concealment of a future lost frames in an IMDCT based decoder.

Turning to FIG. 3, during normal operation when the bad frame indicator (BFI) indicates there is no bad frame (i.e., BFI==0), the audio decoder 300 decodes a current frame of the bitstream and transmits the current frame for playback by a playback device. The audio decoder 300 employs in total a 26 ms duration time domain signal for calculating the replacement signal in case of lost frames, the most recent (rightmost) 16 ms part of the decoded signal, with length Lₚᵣₒₜ samples is called the prototype signal x_{right}(n) that is stored in TD (time domain) buffer 302. The oldest (leftmost) 16 ms part of the decoded signal, with length Lₚᵣₒₜ samples is called the previous prototype signal x_{left}. For a sampling frequency fs of 48 KHz Lprot is 768 samples, and the length of the DFT, N_{FFT} is also 768, (corresponding to (N_{FFT}/2)−1 complex valued coefficients and two real coefficients; X_{F}(0) for the DC(k=0) and X_{F}(N_{FFT}/2) as the Fs/2 real coefficient. Other sampling frequencies are listed in Table 5.33 of the LC3plus audio code specification (ETSI IS 103634) v. 1.4.1

For the first lost frame there are two relevant steps taken. The first step is a fine spectral analysis performed in the sinusoidal analysis block 304. For the first lost frame the prototype frame signal, X_{right}, is used for a fine high-resolution spectral analysis:

$${X}_{F} ( k ) = F F T ( {w}_{h r} ( n ) * {X}_{r ight} ( n ) , 0 \leq n < {L}_{prot} , 0 \leq k \leq {N}_{F F T}$$

where X_{F}(k) is complex valued spectrum, wₕᵣ(n) is a hamming-rectangular window, and Lₚᵣₒₜ is the length of the FFT input which depends on the sampling frequency used.

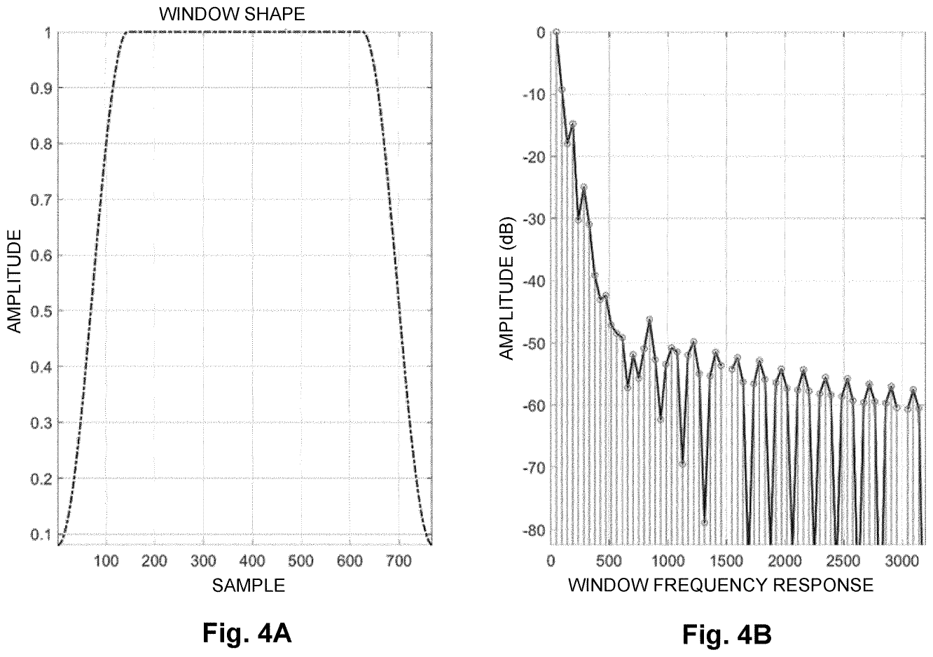

FIG. 4A illustrates window properties of the 16 ms 768 sample LC3plus Phase ECU flat top hamming window, specifically the time domain window coefficients. FIG. 4B illustrates the one-sided frequency response of the window (Hz on the X-axis). One can see in FIG. 4B that for a pure sinusoid the magnitude should drop off with up to 30 dB at a location four bins to the right of the center bin (located at 0 Hz in the figure.)

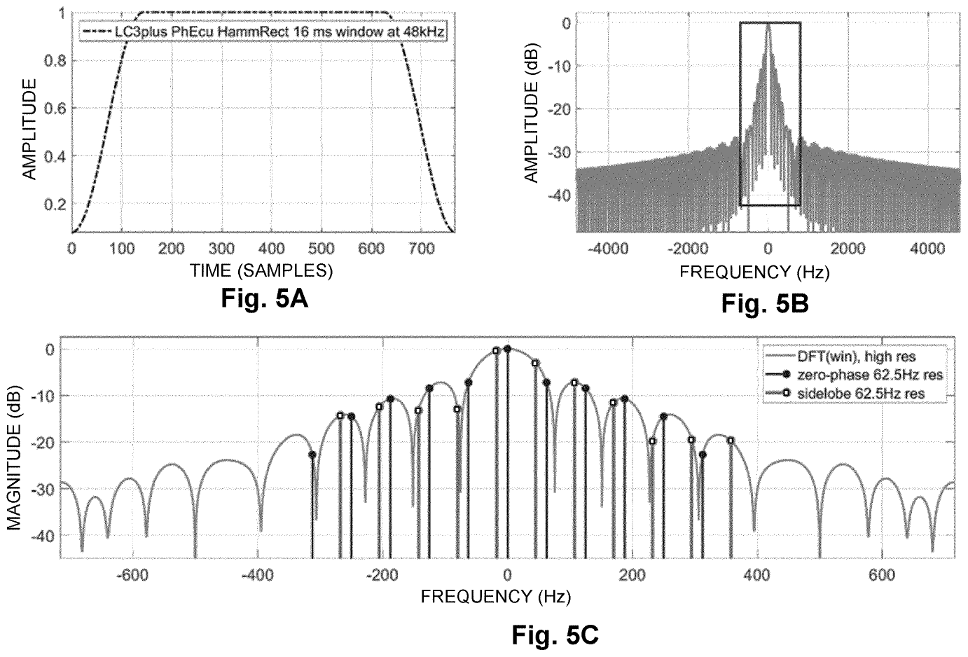

FIG. 5A is a plot of the 16 ms 768 sample LC3plus Phase ECU flat top hamming window in the time domain. FIG. 5B is a plot of the frequency response of the window. FIG. 5C is a “zoom-in” of the plot of FIG. 5B and additionally shows two different phase positions that may arise when using the window, on top of a high resolution view of the window's magnitude response.

In case of a burst error consecutive frames are based on the same prototype signal analysis so the complex valued spectrum X_{F}(k) is saved. To locate the peaks in the spectrum, the magnitude spectrum is first calculated |X_{F}(k) | in the magnitude calculation block 306 to form the magnitude spectrum Xabs(k) and this is sent to the FD peak locator 308. The FD peak locator 308 analyzes the spectrum X_{F}(k) to find sinusoidal peaks. The peak bins in X_{F}(k) are found by employing a Frequency Domain (FD) Peak Locator method. The FD Peak Locator 308 identifies n_plocs_orig peaks as plocs[p], p∈0 . . . n_plocs_orig−1 by localizing local maxima in combination with a threshold, in the magnitude spectrum Xabs(k). There are several possible methods for finding these local maxima in a signal, however one efficient non-iterative method employing derivative analysis is given in the LC3plus audio codec specification, v 1.4.1 c-code, specifically function plc_phEcu_peak_locator_fxlike( ) in file “\src\floating_point\plc_phecu_spec_ana.c”

The noise-like peak analysis 310 is used in scenarios where the FD peak locator 308 identifies numerous peaks (e.g., 14 or more local maxima found as peaks and at least one of those peaks is located in the 0-400 Hz voiced region). When this occurs, the signal is assumed to be a pure background noise signal and the noise-like peak analysis block 310 actively forces the counter n_plocs to zero. Thus, the output of noise-like peak analysis block 310 is either n_plocs-orig or zero. The effect of this zeroing is that any evolution of then artificially sounding sinusoids is completely inhibited.

The single sinusoid identification 312 is used in scenarios where the FD peak locator 308 identifies very few peaks (e.g., 1 or 2 local maxima found). When this occurs, a single clean sinusoid is assumed and the single sinusoid identification 312 sets a flag, one_peak_flag_mask to zero to disable valley noise generation. This avoids generation of potentially annoying granular background noise in combination. In the phase evolution step, the flag one_peak_flag_mask when set to zero may be used to indicate that the amplitudes of all valley bins in X′_{F}(k) (also known as a phase evolved complex valued spectrum or the modified Frequency coefficients) be set to zero. The default value of the one_peak_flag_mask flag is “−1” corresponding to a 16 bit all ones binary sequence, which will maintain the amplitude as estimated from x_{right}(n) and stored as complex valued pairs in X_{F}(k).

The identified peaks bins and adjacent sinusoid contribution bins in X_{F}(k) are time evolved as sinusoids in the frequency domain using n_plocs, plocs[ ], and the variable one_peak_flag_mask as additional inputs into FD Phase Evolution 314, which creates X′_{F}(k), where the remaining identified valley bins (the non-sinusoid bins) in X_{F}(k) are evolved by scrambling the phases of the valley bins in the frequency domain.

The modified Frequency coefficients X′_{F}(k) are subsequently converted back to the time domain by sinusoidal synthesis 316. While the exact time evolution of the sinusoids of the windowed prototype signal frame would require complex super position of frequency-shifted, phase-evolved and sampled instances of the spectrum of the used window function, the sinusoidal synthesis 316 operates with an approximation of the window function spectrum such that it comprises only a region around its main lobe. With this approximation, the substitution frame spectrum is composed of strictly non-overlapping portions of the approximated window function spectrum and hence the time evolution of the sinusoids of the windowed prototype signal frame reduces to phase shifting the sinusoidal components of the prototype spectrum in δ-regions around each spectral peak j by an amount θ(j). The phase shift is calculated as:

$$θ ( j ) = 2 π \cdot \frac{{k}_{p}^{′} ( j )}{{L}_{prot}} \cdot ( 2 \cdot L - \frac{2 \cdot L - {L}_{prot}}{2} - \frac{L}{2 + {k}_{o f f s}} - K ) , 0 \leq j < {N}_{p e a k}$$

where k′ₚ(j) represents a fractional peak location after interpolation and k_{offs} is the offset in number of samples since the last good frame. k_{offs} is incremented by L for each lost frame, and L equals the length of the frame. For a sampling frequency fs of 48 KHz Lprot is 768 samples, L is 480 samples, and K is a tunable analysis shift parameter that may be set to 0. Next the spectrum around each spectral peak j is evolved and random noise component related to burst loss handling is added:

$${X}_{F}^{′} ( k ) = ∝ ( k ) \cdot {X}_{F} ( k ) \cdot {e}^{i \cdot θ ( j )} + β ( k ) \cdot {\overline{G}}_{tran} ( k ) \cdot {e}^{i \cdot 2 π \cdot rand ( k )}$$

where k=j−δ₁, . . . j+δ₂, ∝(k) and β(k) are attenuation factors, kₚ(j) is an integer representing peak location, G̅ₜᵣₐₙ(k) is a low-resolution magnitude spectrum of the previous good frame, and rand(k) is a random number between 0 and 1

$${δ}_{1} = min ( 5 , \frac{{k}_{p} ( j ) - {k}_{p} ( j - 1 ) - 1}{2} )$$

$${δ}_{2} = min ( 5 , \frac{{k}_{p} ( j + 1 ) - {k}_{p} ( j ) - 1}{2} )$$

$$0 \leq j < {N}_{p e a k}$$

The remaining spectral coefficients which have not been evolved are processed in similar manner but with a randomized phase.

In a final step, in the time domain (TD) frame reconstruction 318, the evolved frequency domain signal X′_{F}(k) is converted to a time domain signal xₚₕ(n) in accordance with

$${x}_{p h} ( n ) = IFF T ( {X}_{F}^{′} ( k ) ) / wh r ( n ) , 0 \leq n < {L}_{prot} , 0 \leq k \leq {N}_{F F T}$$

After the initial frame reconstruction an overlap add is performed with the previously decoded signal and then TDA (time domain aliasing) and ITDA (inverse TDA) steps of the MDCT (modulated discrete cosine transform) and IMDCT (inverse MDCT) are run, to generate the current frame's concealed output (i.e., a replacement frame) and the OLA buffer signal for the next correctly received frame.

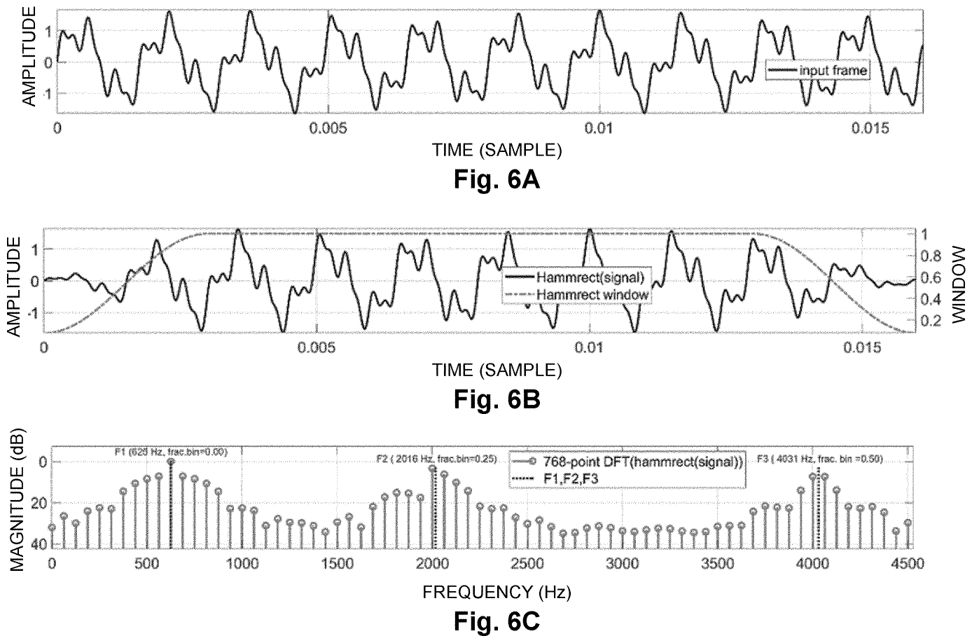

FIG. 6A illustrates an example 16 ms input signal with three added and clearly frequency separated sinusoids, in this case a test signal with these sinusoid frequencies (625 Hz, 2016 Hz, and 4031 Hz). FIG. 6B illustrates the flat top hamming window and the windowed signal. FIG. 6C illustrates the frequency domain (DFT) phase positions that arise when analyzing these three sinusoid signals. Note that the last sinusoid has two equally strong peaks in the DFT bin domain even though the input in this frequency region is a single sinusoid. Further, note that the sinusoid at 2016 Hz may result in two peak-locator function localized peaks, one at 2000 Hz and one at 1875 Hz.

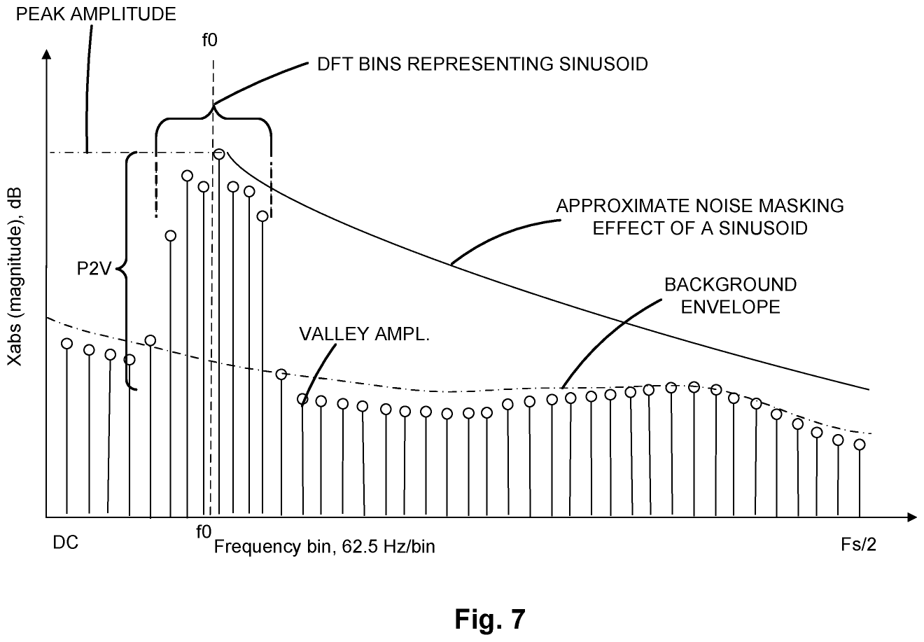

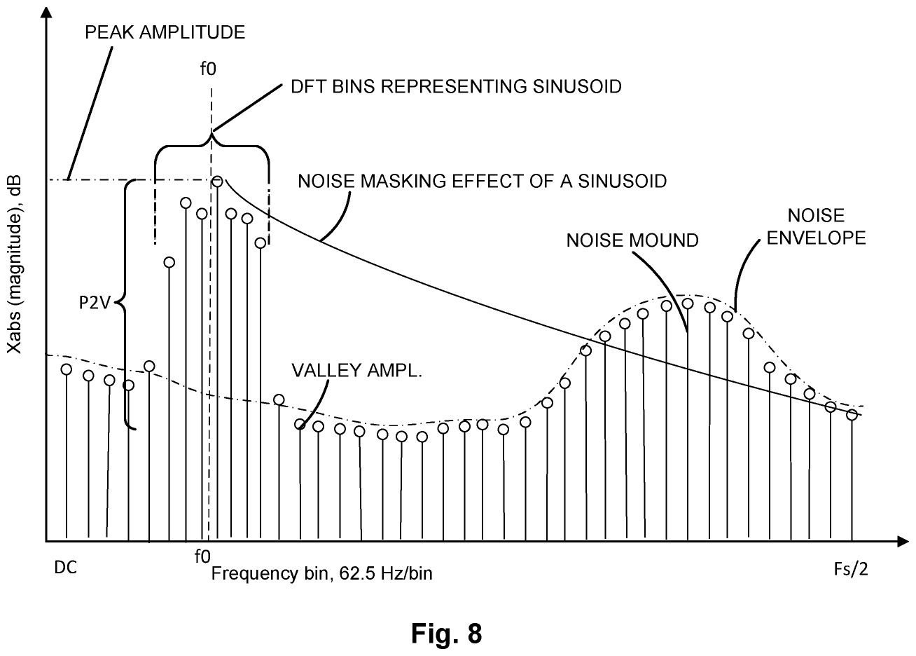

FIGS. 7 and 8 illustrate types of signals that show insignificant background noise (FIG. 7) and signification background noise (FIG. 8).

FIG. 7 illustrates a DFT spectrum of a single sinusoid with added subjectively insignificant background noise, f0 is the location of a single sinusoid. The Dash-dot outlines the envelope of the background spectrum. P2V indicates the local Peak-to-Valley Ratio that one may obtain around f0.

FIG. 8 illustrates a DFT spectrum of a single sinusoid with subjectively significant background noise. The “noise mound” indicates where the significant background noise is located. f0 is the location of a single sinusoid. Dash-dot outlines the envelope of the background spectrum. P2V indicates the local Peak-to-Valley Ratio that one may obtain around f0 using an analyzed Peak amplitude and an analyzed Valley amplitude.

Various embodiments provide an improved and low-complex identification of pure single sinusoids. The various embodiments perform two main steps. The first step is to identify a candidate pure sinusoid based on the initial crude method (i.e., one or two peaks identified in a local maxima peak search of the absolute spectrum) as described above with respect to FIG. 3.

The second step is rejection of initial sinusoid hypothesis of the first step. In the second step, if multiple peaks are present they have to be close enough, to be accepted as two peak bins representing a pure single sinusoid (peaks located within a ~300 Hz range on the frequency scale). If they are not close enough, then the initial sinusoid hypothesis is rejected.

The local Peak to Valley amplitude Ratio (P2V-ratio) for the largest peak (out of the 1-2 peaks) has to be sufficiently large. For example, the deepest of left or right valley bin amplitudes must be 16 times lower than the peak (yielding at least 20 log 10(16)=24.08 dB local P2V ratio). If not, then the initial sinusoid hypothesis is rejected.

A band-wise frequency envelope estimate for the last 16 ms to 26 ms is analyzed outside the sinusoid vicinity for inconsistencies in relation to a likely pure single sinusoid envelope shape:
if a significant perceptually weighted amplitude increase is identified (accumulated increase higher than a threshold of 4.5 dB) in the region above the assumed tonal band;
or if the band-wise envelope shows significant perceptually weighted amplitude decay (accumulated decay higher than a threshold of 4.5 dB) in the region below (in terms of frequency) the assumed tonal band;
or if the accumulated perceptually weighted lower and higher band changes exceed a threshold (accumulated LF-decay+HF-increase is higher than a threshold of 6.0 dB—this band analysis essentially verifies that the band amplitude estimates are tapering off in a consistent way around an assumed single sinusoid position);
   then the initial single pure tone hypothesis is rejected.

Thus, the frequency envelope surrounding an assumed single sinusoid peak is analyzed, taking into account the perceptual hearing sensitivity properties, when rejecting (or accepting) the initial single pure sinusoid hypothesis. Doing this based on low computationally complexity band wise analysis, taking into account the envelope evolution below and above the assumed sinusoidal tone location in terms of frequency and the joint evolution on both sides of the location of the assumed sinusoid location.

Using the various embodiments may achieve preserved high SNR (signal to noise ratio) generation of pure single sinusoids without adding DFT valley bin noise, when there is a truly single sinusoid present, without perceptually important information in valley regions. And when there is a single sinusoid with significant perceptual information in the low, high or both high and low frequency regions surrounding the sinusoid, those frequency regions will now correctly be generated including DFT valley bin noise injection.

The various embodiments are also robust in an absolute level sense, i.e., analysis of differences/deltas do not require an analysis of an absolute sound level.

A typical example when this analysis is of high importance is when a recording microphone picks up a wide bandwidth rather low-level room recording or environment noise and a single sinusoid from e.g., a musical instrument, then the proper error concealment strategy requires that the noise envelope is maintained, even at the cost of a slightly degraded single pure sinusoid generation.

If the tone signal with low level room/background noise is generated as a pure sinusoid the result will be an annoying feeling of lost audio bandwidth during the concealment period, on the other hand if the sinusoidal tone is generated with a proper noise envelope, the packet loss is barely heard.

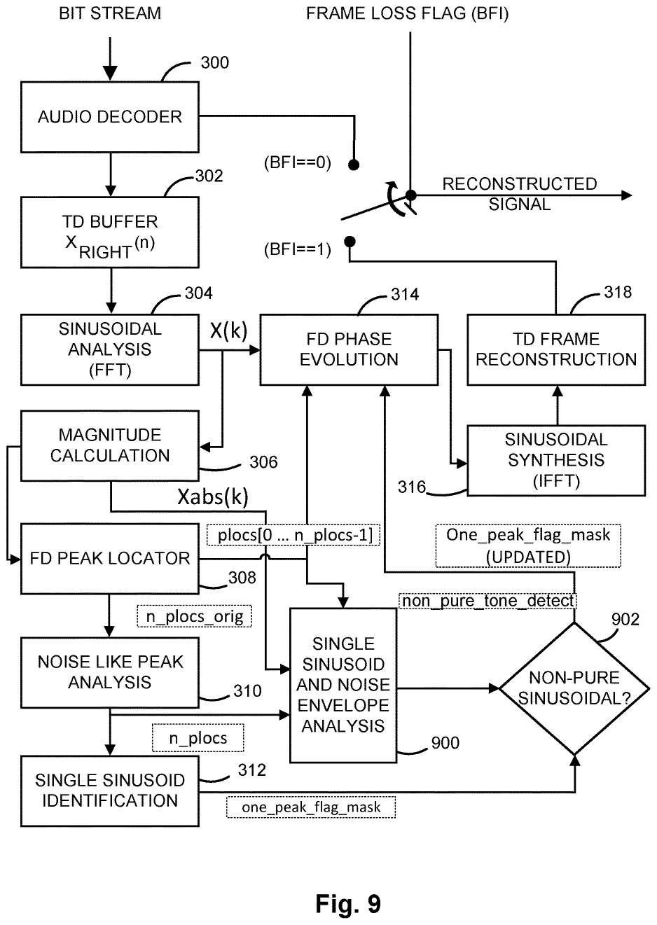

FIG. 9 illustrates a block diagram of a sinusoidal analysis and regeneration PLC with an added single sinusoid and noise-envelope analysis block 900 that identifies a subjectively significant background signal. The single sinusoid and noise-envelope analysis block 900 receives the magnitude spectrum Xabs(k) from the magnitude calculation block 306, the peak locations plocs[0 . . . n_plocs−1] from the FD peak locator 308, and the number of peak locations n_plocs from the noise-like peaks analysis 310, and outputs a non_pure_tone_detect indication.

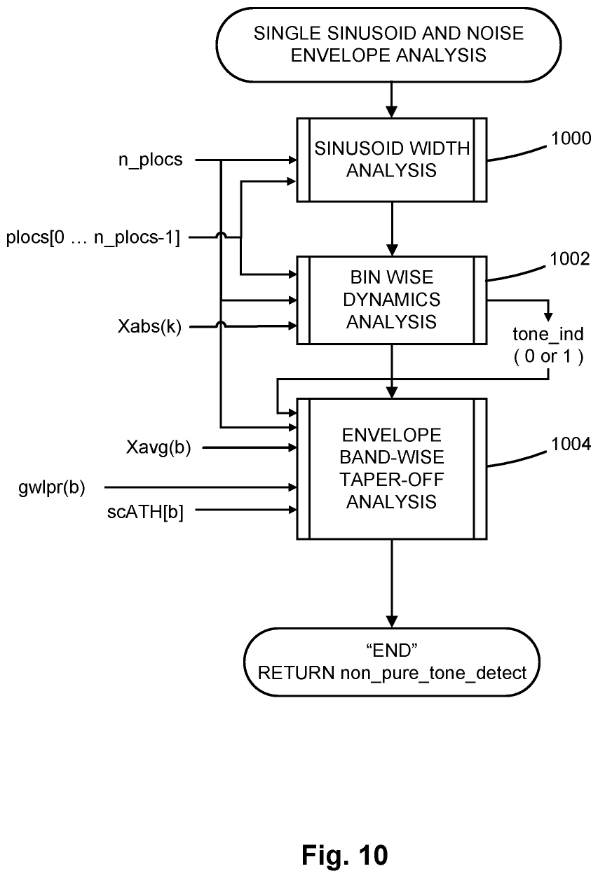

FIG. 10 is a flowchart for the single sinusoid and noise-envelope analysis block 900. The fine spectral estimation may be obtained the same way as described above, X_{F}(k) for FFT coefficients, k∈[0 . . . (Lprot/2−1)], (with Lprot==768 for a sampling rate of 48 kHz). For the first lost frame the prototype frame signal, x_{right}, is used for a fine high-resolution spectral analysis:

$${X}_{F} ( k ) = F F T ( {w}_{h r} ( n ) \cdot {x}_{right} ( n ) ) , 0 \leq n < {L}_{prot} , 0 \leq k \leq {N}_{F F T}$$

where X_{F}(k) is complex valued, wₕᵣ(n) is a hamming-rectangular window, and Lₚᵣₒₜ is the length of the FFT input which depends on the sampling frequency used as described above.

The shape of the window is defined as a periodic hamming window:

$${w}_{h r} ( n ) = \{ \begin{matrix}0.56 + 0.46 \cdot cos ( \frac{π \cdot n}{{L}_{h} + 1} ) & , & 0 \leq n < {L}_{h} \\ 1. & , & {L}_{h} \leq n < L - {L}_{h} \\ 0.56 + 0.46 \cdot cos ( \frac{π \cdot ( n - {L}_{prot} + 2 \cdot {L}_{h} )}{{L}_{h} + 1} ) & , & L - {L}_{h} \leq n < {L}_{prot}\end{matrix}$$

Lₕ is the length of the hamming part which depends on the sampling frequency fₛ and is 96 samples at 48 KHz.

### Obtaining the Coarse Band-Wise Spectral Representation

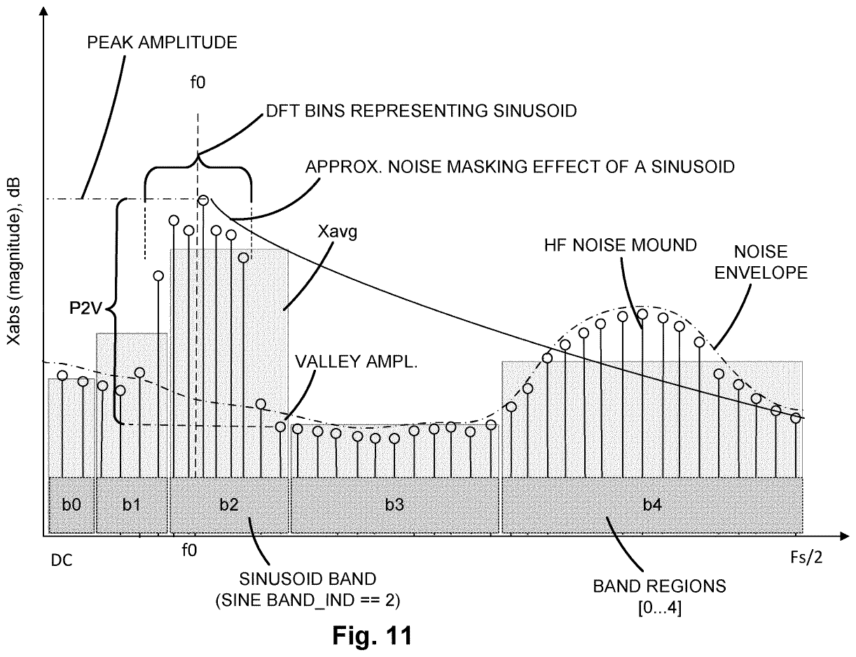

FIG. 11 shows an example where subbands in general are used for analysis of the spectrum, in general subband level analysis decreases both complexity in terms of cycles and storage of tables compared to DFT bin analysis, and further the band wise analysis makes it easier to match the DFT bins to perceptual meaningful domain. In this description the band estimates Ēₜᵣₐₙ(k) is named Xavg(b) (e.g., a sub-band energy estimate (long term)), where the band index b ranges from 0 to (Ngrp−1) with Ngrp==8, (in the tables below an extra band index value of 8 is used to identify the end bin of (band Ngrp−1).)

As described herein, various embodiments will, for the Low Frequency (LF) region, evaluate the ratio of Xavg(0) vs Xavg(1), and for the High Frequency (HF), evaluate the ratio Xavg(3) vs Xavg(4). For the both LF- and HF-side evaluation accumulation of the ratios larger than 1.0 out of Xavg(0)/Xavg(1) and Xavg(4)/Xavg(3), will be summed up. In the evaluation, ATH-based weights are applied to the ratios before accumulation.

The coarse spectral representation X_{F}(k) for FFT coefficients, k∈[0 . . . (Lprot/2−1)], (with Lprot==768 for a sampling rate of 48 kHz), may be obtained the same way as in ETSI TS 103 634 V1.4.1 chapter “5.6.3.4.2 Spectral Shape” and “5.6.3.4.3 Transient analysis”. The result is a vector of band amplitude estimates in Ēₜᵣₐₙ:

$${\overline{E}}_{tran} ( k ) = \sqrt{\frac{1}{2} \cdot \frac{{E}_{left} ( k ) + {E}_{r ight} ( k )}{grp\_start \_bin ( k + 1 ) - grp\_start \_bin ( k )}} ,$$

$$0 \leq k < {N}_{g r p}$$

The band limits for Ēₜᵣₐₙ(k)) used in ETSI TS 103 634 V1.4.1 are: “grp_start_coef(k)={4, 14, 24, 44, 84, 164, 244, 324, 404}”, with 50 Hz per MDCT line in LC3plus—this corresponds to bandlimits in Hertz as follows

| | | | | Employed start | |
|---|---|---|---|---|---|
| | (Start | | | DCT bins with | Band range and |
| | MDCT line | | | 62.5 Hz/bin | bandwidth in |
| Band | in [1]) 50 Hz | Corresponding | | resolution | terms of DFT |
| number | resolution | MDCT line | Band range and | gwlpr as used | bins as used in |
| (b) | grp_start_coef | value in Hertz | bandwidth in Hz | in this solution | this solution. |
| 0 | 4 | 200 | [200- | 1 | [62.5- |
| | | | 700[=500 Hz | | 750[=625 Hz |
| 1 | 14 | 700 | [700- | 12 | [750- |
| | | | 1200[=500 Hz | | 1250[=500 Hz |
| 2 | 24 | 1200 | [1200- | 20 | 1250- |
| | | | 2200[=1 kHz | | 2250[=1 kHz |
| 3 | 44 | 2200 | [2200- | 36 | 2250- |
| | | | 4200[=2 kHz | | 4250[=2 kHz |
| 4 | 84 | 4200 | [4200- | 68 | 4250- |
| | | | 8200[=4 kHz | | 8250[=4 kHz |
| 5 | 164 | 8200 | [8200- | 132 | 8250- |
| | | | 12200[=4 kHz | | 12250[=4 kHz |
| 6 | 244 | 12200 | [12200- | 196 | 12250- |
| | | | 16200[=4 kHz | | 16250[=4 kHz |
| 7 | 324 | 16200 | [16200- | 260 | 16250- |
| (Ngrp-1) | | | 20000] = 4 kHz | | 20250[=4 kHz |
| (8) | 404 (end + | 20200 | n/a | (324) (end + | n/a |
| | 1 line | | | 1 bin | |
| | for band 7) | | | for band 7) | |

In the various embodiments herein, the FFT derived DFT starting bins, gwlpr[8+1]={1, 12, 20, 36, 68, 132, 196, 260, 324}; are used.

Another possibility of obtaining a Xavg(b) estimate is by computing a Welch like spectral estimate by using a previous(left) 16 ms FFT analysis and a current(right) frame's 16 ms FFT analysis as follows:

$${{X}_{F} ( k )}_{r ight} curr = FFT ( {w}_{h r} ( n ) \cdot {x}_{r ight} ( n ) ) , 0 \leq n < {L}_{prot} , 0 \leq k \leq {N}_{F F T}$$

$${{X}_{F} ( k )}_{left} corr = FFT ( {w}_{h r} ( n ) \cdot {x}_{left} ( n ) ) , 0 \leq n < {L}_{prot} , 0 \leq k \leq {N}_{F F T}$$

Compute the magnitudes |X_{F}(k)_{right}| and |X_{F}(k)_{left}| and sum of the average for each band as follows:

$$X a v {g}_{r ight} ( b ) = \frac{1}{g w l p r ( b + 1 ) - g w l p r ( b )} {\sum }_{k = g w l p r ( b )}^{g w l p r ( b + 1 ) - 1} \vert {{X}_{F} ( k )}_{r ight} \vert ,$$

$$0 \leq b < {N}_{g r p}$$

$$Xav {g}_{left} ( b ) = \frac{1}{g w l p r ( b + 1 ) - g w l p r ( b )} {\sum }_{k = g w l p r ( b )}^{g w l p r ( b + 1 ) - 1} \vert {{X}_{F} ( k )}_{left} \vert , 0 \leq b < {N}_{g r p}$$

Use the average of the two 16 ms sub band averages as a final 26 ms spanning Xavg(b) estimate:

$$Xavg ( b ) = 0.5 * ( X a v {g}_{left} ( b ) + X a v {g}_{r ight} ( b ) ) , 0 \leq b < {N}_{g r p}$$

Obtaining the initial number of peaks and peak locations from a FD Peak Locator 308. The FD Peak Locator 308 identifies n_plocs_orig peaks as plocs[p], p∈0 . . . n_plocs_orig−1 by localizing local maxima in combination with a threshold, in the magnitude spectrum Xabs(k).

There are several possible methods for finding the peaks as the local maxima in a signal, however one efficient non-iterative method employing derivative analysis is given in the floating point c-code of the LC3plus audio codec specification, v 1.4.1 c-code—see function plc_phEcu_peak_locator_fxlike( ) in file “\src\floating_point\plc_phecu_spec_ana.c”. The output of the function is a list of local maxima (a.k.a. peaks), with varying length n_plocs, depending on the dynamics and peakiness of the signal.

The two existing methods “Noise like peaks signal analysis” and “Single sinusoid identification” as outlined above in the description of FIG. 3, are also used to provide n_plocs peaks as plocs[p], p∈0 . . . n_plocs−1

Optionally, for single sinusoid identification (but used in general in the existing LC3plus analysis for enhanced evolution) to increase the frequency resolution the spectrum, peak locations may be sent to a refinement method that use real valued and/or complex valued interpolation. After the interpolation, the sinusoid peak locations are fractional peak locations plocs(j), j=0, . . . , n_plocs−1

### Obtaining the Initial Single Tone Hypothesis, Based on Number of Established Peaks

If the number of peaks indicated by n_plocs is 1 or 2 an extended analysis is made.

The variable non_pure_tone_detect is initially set to zero (16 binary zeroes in an integer of length 16).

The variable non_pure_tone_detect is used where the results of five sub analysis in binary positions b0, b1 and b4, b5, b6 are set. Where a one in any of b{*} (*∈{0,1,4,5,6}) will indicate that the sinusoid is a non-pure sinusoid and therefore one should synthesize the signal with maintained valley energy in the valley phase scrambling phase of the PLC valley bin processing.

### Main Sinusoidal Lobe Width Analysis (Sinusoid Width Analysis Block 1000)

A single pure sinusoid cannot have a too wide main lobe. If the main lobe is too wide it indicates that the signal has added significant noise or stems from two different sinusoids,

If there are two peaks identified and the distance between is larger or equal to 250 Hz (4*62.5 Hz), then the b0 register of non_pure_tone_detect is set to 1;

$$b 0 = \{ \begin{matrix}1 , & \vert plocs ( 1 ) - plocs ( 0 ) \vert < 250 Hz \\ 0 , & otherwise\end{matrix}$$

In c-code, the above can be written as:

/* no single sine optimization when 2 peaks are
too wide apart enough to represent a single
sinusoid */
if (n_plocs == 2 && (plocs[1] − plocs[0]) >=
ONE_SIDED_SINE_WIDTH) /* NB, plocs is an
ordered vector */
{
non_pure_tone_detect |= 0x1;
}

### Bin-Wise Dynamics Analysis Block 1002

A true sinusoidal tone should have high enough dynamics, as allowed by the employed DFT analysis window.

In case there are two peaks (n_plocs==2), which peak is to be assumed as an estimation of the center location is identified. The peak with the largest amplitude is assumed to be the center peak plocs(tone_ind).

$$tone\_ind = arg {max}_{p = 0 , 1} ( [ X abs ( p l o c s [ 0 ] ) , X abs ( p l o c s [ 1 ] ) ] )$$

The range for the local dynamics analysis is defined as from DFT bin low_ind to and including high_ind, as follows:

$$low\_ind = MAX ( 62 \text{.5} , ( plocs [ tone\_ind ] * 62.5 ) - 312.5 Hz ) / 62.5 ;$$

$$high\_ind = MIN ( Fs / 2 - 62.5 , ( plocs [ tone\_ind ] * 62.5 ) + 312.5 Hz ) / 62.5 ;$$

i.e., if the analysis region is not bounded by the endpoints, one will analyze a region of 625 Hz.

In c-code, the above can be written as:

```
/* local bin wise dynamics analysis, if 2
peaks, we do the analysis based on the
  location of the largest peak */
    tone_ind = 0;
    plc_phEcu_fft_spec2_sqrt_approx(&(X[plocs[0]]),
    1, &peak_amp);
    /* get 1st peak amplitude = approx_sqrt(Re\hat{ }2+Im\hat{ }2) */
    if ((n_plocs − 2) == 0)
    {
      plc_phEcu_fft_spec2_sqrt_approx(&(X[plocs[1]]),
      1, &peak_amp2); /* get 2nd peak
amplitude */
      if (peak_amp2 > peak_amp)
      {
        tone_ind = 1;
        peak_amp = peak_amp2;
      }
    }
    low_ind=MAX(1, plocs[tone_ind] −
    (ONE_SIDED_SINE_WIDTH + 1));
    /* DC is not allowed as valley */
    high_ind=MIN((Lprot >> 1)−2, plocs[tone_ind] +
    (ONE_SIDED_SINE_WIDTH + 1));
    /* Fs/2 is not allowed as valley */
    n_ind = high_ind − low_ind + 1;
```

The lowest valley in the local analysis region is established as:

$$valley\_ind = {arg min}_{k = l o {w}_{i n d} … high \_ ind} ( X abs ( k ) )$$

In c-code, the above can be written as:

```
/* find lowest amplitude around the assumed main lobe center location */
  plc_phEcu_fft_spec2_sqrt_approx(&(X[low_ind]), n_ind, x_abs);
  valley_amp = peak_amp;
  for (i = 0; i < n_ind; i++) {
    valley_amp = MIN(x_abs[i], valley_amp);
  }
```

If the local P2V-Ratio (Peak-to-Valley ratio) is too low (less than 24.0 dB), set the b1 bit of the non_pure_tone_detect register, to detect a nonpure sinusoid, as follows.

$$b 1 = \{ \begin{matrix}1 , & \frac{Xabs ( plocs ( tone\_ind ) )}{Xabs ( valley\_ind )} < 24. dB \\ 0 , & otherwise\end{matrix}$$

In c-code, the above can be written as:

```
/* at least a localized amplitude ratio of 16 (24 dB)
    required to declare a pure sinusoid */
  if (peak_amp < 16 * valley_amp) /* 1/16 easily
  implemented in BASOP */
  {
      non_pure_tone_detect |= 0x2; /* not a
      pure tone due to too low local SNR */
  }
```

### Perceptual Sub-Band Tapering Analysis, Band Determinations

Establish which band(s) the assumed single sinusoid is occupying as follows:

$$ind\_pre ( b ) = \{ \begin{matrix}b , & plocs ( tone\_ind ) \geq gwlpr ( b + 1 ) , b ∈ 0 … ( Ngrp - 1 ) \\ - 1 & otherwise\end{matrix}$$

$$ind\_low = {arg max}_{b = 0 … ( Ngrp - 1 )} ind\_pre ( b )$$

$$ind\_high = ind\_low$$

In c-code, the above can be written as:

```
  /* analyze LF/ HF bands energy dynamics vs the assumed single tone band
        ( one or two peaks found) */
  {
    fs_idx = (LC3_INT16)floor(Lprot / 160); /* fs_idx */
    assert(fs_idx < 5);
    /* Xavg, is a vector of rather rough MDCT/(or DFT) based band energy estimates in
perceptually motivated bands. from approximately the last 26 ms of synthesis */
    /* eval amplitude relations for assumed tonal band vs lower and higher bands */
    Ngrp = xavg_Ngrp[fs_idx]; /* { 4 NB , 5 WB , 6 SSWB , 7 SWB, 8 FB }; */
    /* establish band(s) with assumed sinusoid tone */
    /* if tone freq location is below first band definition, use first band as location anyway */
    i = 0; /* band 0 , 1 , 2 , 3 , ...*/
    while (plocs[tone_ind] >= gwlpr[i + 1]) { /* gwplr= [ 1, 12(750Hz), 20(1250Hz) ,
36 , .. */
      /* fftbin-indexes “0”...11, 12...19, 20...35, 36 ... */
      i++;
    }
    sineband_ind_low = i;
      sineband_ind_high = i; /* typically in the same band as low */
```

Refine band(s) for which the assumed single sinusoid is occupying by analyzing the vicinity of the main lobe to a band border as follows:

$$ind\_low = \{ \begin{matrix}ind\_high - 1 , & \begin{matrix}ind\_high > 1 \\ AND \\ ( plocs [ tone\_ind ] * 62.5 - 250 Hz ) \geq \\ gwlpr ( ind\_high + 1 )\end{matrix} \\ ind\_low , & otherwise\end{matrix}$$

$$ind\_high = \{ \begin{matrix}ind\_low + 1 , & \begin{matrix}ind\_low > ( Ngrp - 1 ) \\ AND \\ ( plocs [ tone\_ind ] * 62.5 + 250 Hz ) \geq \\ gwlpr ( ind\_low + 1 )\end{matrix} \\ ind\_high , & otherwise\end{matrix}$$

In c-code, the above can be written as:

```
    /* a single tone may end up on a band border
      , handle case when assumed tone is more or less right in between two perceptual bands +/−
4 62.5 Hz */
    if ((sineband_ind_high > 0) &&
        (plocs[tone_ind] − ONE_SIDED_SINE_WIDTH) >= gwlpr[sineband_ind_high + 1]
        ) {
        sineband_ind_low = sineband_ind_high − 1;
    }
    if ( (sineband_ind_low < (Ngrp − 1)) &&
          (plocs[tone_ind] + ONE_SIDED_SINE_WIDTH) >= gwlpr[sineband_ind_low + 1]
          ) {
        sineband_ind_high = sineband_ind_low + 1;
    }
  }
```

ind_low and ind_high may be pointing to the same band, or pointing to bands adjacent to each other.

### Perceptual Sub-Band Tapering Analysis Block 1004

In the following steps the amplitude evolution in the bands below ind_low and above ind_high may now be evaluated: As long as there are at least two bands available on either the LF side or the HF-side.

Only a limited weighted accumulated envelope increase is allowed in the HF side.

Only a limited weighted accumulated envelope decay (from lower band to higher band) is allowed in the LF side.

Only a limited weighted accumulated envelope total change is allowed in a combined LF side and HF side summation.

Further, to avoid costly fixed point divisions, the band ratio analysis may be performed directly in a logarithmic domain, using addition and subtractions at the cost of converting the Ngrp amplitudes to the log (e.g., base2) domain only once.

The bands above ind_high are analyzed for consistent tapering off. This is achieved by accumulating the band wise larger than 1.0 (0.0 dB) amplitude ratios between bands from the lowest to the highest.

$$tot\_inc \_HF = {\sum }_{i = ind \_ high + 1}^{( Nrgp - 1 )} scATH ( i ) * max ( 0. dB , 20 log 10 ( \frac{Xavg ( i + 1 )}{Xavg ( i )} ) )$$

where scATH(i) is given by:

$$float scATH [ Ngrp - 1 ] = \{ 0.4554443359375 , 0.930755615234375 , 0.97308349609375 , 0.999969482421875 , 0.90850830078125 , 0.775665283203125 , 0.5 \} ;$$

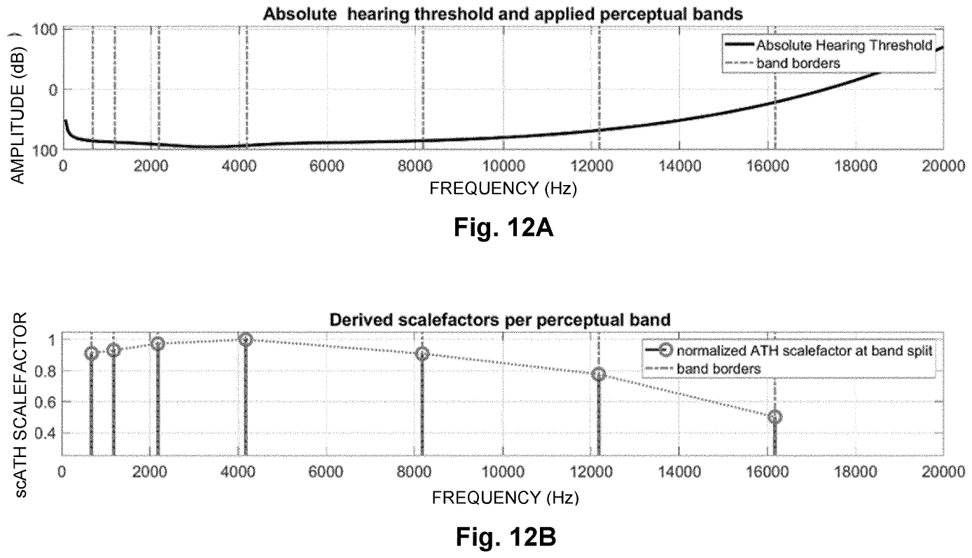

These are perceptual weighting factors for the band border frequencies, derived from an inverted and compressed absolute hearing threshold curve. See FIGS. 12A and 12B for a view of the ATH curve and the derived perceptual scaling factors. FIG. 12A shows that the ear is most sensitive at roughly 3.5 kHz. FIG. 12B depicts corresponding ATH derived weighting scalefactors at band borders (these scalefactor scATH indicates a relation between two bands). The scATH curve above was normalized so that the maximum down-weighting at the 16 kHz border was 50%, resulting in a scale factor of 0.5. This normalization of scale factors was found experimentally by analyzing signals with unmasked background noise, i.e., using this kind of ATH-weighting, changes/deltas located at band splits at approximately 3-4 kHz are deemed much more important than changes/deltas at band splits at 12 and 16 kHz.

In c-code, the above can be written as:

```
/* delta tapering-off analysis,
  not sensitive to input bandwidth limitation and levels */
  /* verify that an assumed clean sine does not have any odd HF content indications
    by thresholding the accumulated delta rise in HF side lobes */
for (I = (sineband_ind_high + 1); i < (Ngrp − 1); i++) {
  tmp = (Xavg[i + 1] + EPS) / (Xavg[i] + EPS);
  tmp_dB = 20.0*log10(tmp);
  if ((Xavg[i] + EPS) > (Xavg[i + 1] + EPS)) {
    tmp_dB = 0;
  }
```

The bands below ind_low are analyzed for consistent tapering off. This is achieved by accumulating the band wise larger than 1.0 (0.0 dB) amplitude ratios between bands from the highest to the lowest.

$$tot\_inc \_LF = {\sum }_{i = max ( 0 , {ind}_{l o w} - 1 )}^{0} scATH ( i - 1 ) * max ( 0. dB , 20 log 10 ( \frac{Xavg ( i - 1 )}{Xavg ( i )} ) )$$

where scATH(i) is again given by:

$$float scATH [ Ngrp - 1 ] = \{ 0.4554443359375 , 0.930755615234375 , 0.97308349609375 , 0.999969482421875 , 0.90850830078125 , 0.775665283203125 , 0.5 \}$$

In c-code, the above can be written as:

```
  /* delta tapering-off analysis, decay */
  /* verify that an assumed clean sine does not have any odd LF content indications
        by thresholding the accumulated delta decay in the LF side lobe */
  /* verify that an assumed clean sine does not have any odd LF content by thresholding the
accumulated LF reverse up tilt */
  for (i = MAX(0, (sineband_ind_low − 1)); i > 0; i−−) {
      tmp = (Xavg[i − 1] + EPS) / (Xavg[i] + EPS);
      tmp_dB = 20.0*log10(tmp); /*log2 constants used in fixed point */
      if ((Xavg[i − 1] + EPS) < (Xavg[i] + EPS)) {
        tmp_dB = 0;
      }
      tot_inc_LF += scATHFx[i − 1] * tmp_dB;
      /* “psychoacoustic” scale using i−1 is ATH factor between band i−1, and band i ,
          based on the assumed Hearing sensitivity curve */
    }
```

The accumulated weighted deltas are analyzed versus three different thresholds.

$$b 4 = \{ \begin{matrix}1 , & tot\_incHF > 4.5 dB \\ 0 , & otherwise\end{matrix}$$

$$b 5 = \{ \begin{matrix}1 , & tot\_inc \_LF > 4.5 dB \\ 0 , & otherwise\end{matrix}$$

$$b 6 = \{ \begin{matrix}1 , & tot\_inc \_LF + tot\_incHF > 6. dB \\ 0 , & otherwise\end{matrix}$$

In c-code, the above can be written as:

```
if (tot_inc_HF > 4.5){ /* 4.5 dB in log2 is 0.7474 */
      non_pure_tone_detect |= 0x10; /* still not a pure tone, HF side increase is too great*/
  }
  if (tot_inc_LF > 4.5) {
    /* 4.5 dB limit in 4.5 = 20log10(x) corresponds to limit value 0.7474 in log2(x) */
      non_pure_tone_detect |= 0x20; /* still not a pure tone, accumulated LF side increase is too
great*/
  }
  /* verify that an assumed clean sine does not have any odd LF+HF content by thresholding
the accumulated LF+HF unexpected tilt */
  if ((tot_inc_LF + tot_inc_HF) > 6.0) { /* 6 dB limit in 20log10(x) corresponds to limit
value 1.0 in log2(x) */
      non_pure_tone_detect |= 0x40; /* still not a pure tone, LF+HF side variation/increase is
too great*/
  }
```

### Finalization of the Non-Pure Sinusoidal Analysis

A pure sinusoidal tone was not identified if any of the register non_pure_tone_detect bits were set. {b0,b1,b4,b5,b6}, the flag mask used by the Phase Ecu Frequency Domain Evolution block is set appropriately.

In other words:

$$one\_peak \_flag \_mask = \{ \begin{matrix}“ - 1 ” , & nonpure\_tone \_detect > 0 \\ “ 0 ” , & otherwise\end{matrix}$$

If a pure sinusoidal tone was not identified, the value of one_peak_flag_mask is set to “−1” corresponding to a 16 bit all ones binary sequence, leading to that Phase ECU PLC will not mute the valley bins in the FD evolution step. See FIG. 8 for an example signal where that is appropriate.

If a pure sinusoidal tone was finally identified, the value of one_peak_flag_mask is set to “0” corresponding to a 16 bit all zeroes binary sequence, later leading to that Phase ECU PLC will mute the valley bins in the FD Evolution step. See FIG. 7 for an example signal where that is appropriate.

Note that in other embodiments, the value of one_peak_flag_mask may be reversed. In other words:

$$one\_peak \_flag \_mask = \{ \begin{matrix}“ 0 ” & otherwise \\ “ - 1 ” & non\_pure \_tone \_detect > 0\end{matrix}$$

The result of the refined single sinusoidal peak and envelope analysis will be a better concealed sound segment, by the PLC, especially for longer runs of lost frames.

A detailed implementation of the sinusoid single tone identification as a floating point c code example is below.

ANSI-C code

```
/*Constants*/
ONE_SIDED_SINE_WIDTH = 4; /*approximate sidelobe width of tone in terms of FFT bins
*/
                /* 4 corresponds to 256 Hz */
MAX_LGW = 9; /* maximum number of band elements in a band related vector */
EPS = 0.000001; /* very small number , used to avoid division by zero */
QUOT_LPR_LTR = 4 ; /* band grouping constant */
/* Table(s)*/
/*compressed ATH Absolute hearing THreshold function weights at band borders */
const LC3_FLOAT scATHFx[MAX_LGW − 2] = { .455444335937500 , 0.930755615234375
, 0.973083496093750 , 0.999969482421875 , 0.908508300781250 , 0.775665283203125 , 0.5
};
xavg_Ngrp[5]; = { 4 /*NB*/ , 5 /*WB*/ , 6 /*SSWB*/ , 7 /*SWB*/, 8 /*FB*/ }; */
            /* number of bands/a.k.a groups) available for a given sampling rate*/
            /*NB-8000 Hz, WB=16000Hz, SSWB=24000Hz, SWB=32000 Hz, FB=48000 Hz */
gwlpr[MAX_LGW+1] = { 1, 3*QUOT_LPR_LTR, 5*QUOT_LPR_LTR,
9*QUOT_LPR_LTR, 17*QUOT_LPR_LTR, 33*QUOT_LPR_LTR, 49*QUOT_LPR_LTR,
65*QUOT_LPR_LTR, 81*QUOT_LPR_LTR, 97*QUOT_LPR_LTR};
    /* gwlpr= {1, 12 /*(750Hz)*/, 20 /*(1250Hz)*/ , 36 , ...}, yields band starting location+1 in
bins */
/*Data types*/
LC3_INT16 signed 16 bit integer
LC3_INT32 signed 32 bit integer
LC3_FLOAT 24 bit single precision floating point value
Complex, a pair of LC3_FLOAT values representing a complex number with real and imaginary
parts
/*Sub-functions*/
plc_phEcu_fft_spec2_sqrt_approx(Complex xF, int b, xF_abs);
/*
  function computing:
    x_abs(i)=sqrt(x[i].Real² + x[i].Imag²) for i=0...(n−1),
    i.e compute the magnitude for n Complex values
*/ y=log10(x); /* Compute Logarithm for base 10.0 */
/*Input signals*/
plocs vector with n_plocs and peak locations from the peak locator
n_plocs Number of found peaks by the peak_locator( ) in the plocs vector.
X, Complex FFT spectrum of a 16 ms time signal with real and imaginary parts
length(Lprot/2)
Lprot, length of the time signal in samples, 16 ms at 48 kHz results in 768 samples
/*Output signal*/
LC3_INT16 non_pure_tone_detect
/* returned as a 16 bit integer */
/* a non_zero output value indicates that the signal is a non-pure sinusoid */
/*Main function*/
static LC3_INT16 plc_phEcu_non_pure_tone_ana(const LC3_INT32* plocs, const
LC3_INT32 n_plocs, const Complex* X, const LC3_FLOAT* Xavg, const LC3_INT32 Lprot)
  {
    LC3_INT16 non_pure_tone_detect;
    LC3_INT16 n_ind, tone_ind, low_ind, high_ind;
    LC3_FLOAT peak_amp, peak_amp2, valley_amp, x_abs[(1 + 2 *
ONE_SIDED_SINE_WIDTH + 2 * 1)];
    LC3_INT16 sineband_ind_low, sineband_ind_high;
    LC3_INT16 i, fs_idx, Ngrp;
    LC3_FLOAT tmp, tmp_dB, tot_inc_HF, tot_inc_LF;
/* use compressed hearing sensitivity curve to allow
      more deviation in highest and lowest bands */
/* ROM table LC3_FLOAT scATHFx[MAX_LGW − 1] */
/*STEP 4*/
    /* init */
    Non_pure_tone_detect = 0;
    tot_inc_HF = 0.0;
    tot_inc_LF = 0.0;
/*STEP 5A*/
    /* no single sine optimization when 2 peaks are too far apart
              to represent a single sinusoid */
    if (n_plocs == 2 && (plocs[1] − plocs[0]) >= ONE_SIDED_SINE_WIDTH)
            /* NB, plocs is an ordered vector */
    {
      Non_pure_tone_detect |= 0x1;
    }
/*STEP 6A*/
    /* local bin wise dynamics analysis, if 2 peaks, we do the analysis based on the location of the
largest peak */
      tone_ind = 0;
      plc_phEcu_fft_spec2_sqrt_approx(&(X[plocs[0]]), 1, &peak_amp);
                  /* get 1st peak amplitude = approx_sqrt(Re\hat{ }2+Im\hat{ }2) */
      if ((n_plocs − 2) == 0)
      {
        plc_phEcu_fft_spec2_sqrt_approx(&(X[plocs[1]]), 1, &peak_amp2); /* get 2nd peak
amplitude */
        if (peak_amp2 > peak_amp)
        {
          tone_ind = 1;
          peak_amp = peak_amp2;
        }
      }
/*STEP 6B, STEP 6C*/
      low_ind = MAX(1, plocs[tone_ind] − (ONE_SIDED_SINE_WIDTH + 1));
                  /* DC is not allowed as valley */
      high_ind = MIN((Lprot >> 1) − 2, plocs[tone_ind] + (ONE_SIDED_SINE_WIDTH + 1));
                  /* Fs/2 is not allowed as valley */
      n_ind = high_ind − low_ind + 1;
      /* find lowest amplitude around the assumed main lobe center location */
      plc_phEcu_fft_spec2_sqrt_approx(&(X[low_ind]), n_ind, x_abs);
      valley_amp = peak_amp;
      for (i = 0; i < n_ind; i++) {
        valley_amp = MIN(x_abs[i], valley_amp);
      }
      /* at least a localized amplitude ratio of 16 (24 dB) is required to declare a pure sinusoid */
      if (peak_amp < 16 * valley_amp) /* 1/16 easily implemented in BASOP */
      {
        Non_pure_tone_detect |= 0x2;
                    /* not a pure tone due to too low local SNR */
      }
/*Establish possibilities for band-wise identification - STEP 7*/
    /* analyze LF/ HF bands energy dynamics vs the assumed single tone band
            ( one or two peaks found) */
    {
      fs_idx = (LC3_INT16)floor(Lprot / 160); /* fs_idx */
      assert(fs_idx < 5);
      /* Xavg , is a vector of rather rough MDCT(or DFT) based band energy estimates in
perceptually motivated bands. from approximately the last 26 ms of synthesis */
      /* eval amplitude relations for assumed tonal band vs lower and higher bands */
      Ngrp = xavg_Ngrp[fs_idx]; /* { 4 NB , 5 WB , 6 SSWB , 7 SWB, 8 FB }; */
      /* establish band(s) with assumed sinusoid tone */
      /* if tone freq location is below first band definition, use first band as location anyway */
      i = 0; /* band 0 , 1 , 2 , 3 , ...*/
      while (plocs[tone_ind] >= gwlpr[i + 1]) { /* gwplr= [ 1, 12(750Hz), 20(1250Hz) ,
36 , .. */
          /* fftbin-indexes “0”...11, 12...19, 20...35, 36 ... */
        i++;
      }
      sineband_ind_low = i;
      sineband_ind_high = i; /* typically in the same band as low */
      /* a single tone may end up on a band border
        , handle case when assumed tone is more or less right in between two perceptual bands +/−
4 62.5 Hz */
      if ((sineband_ind_high > 0) &&
        (plocs[tone_ind] − ONE_SIDED_SINE_WIDTH) >= gwlpr[sineband_ind_high + 1]
        ) {
        sineband_ind_low = sineband_ind_high − 1;
      }
      if ( (sineband_ind_low < (Ngrp − 1)) &&
          (plocs[tone_ind] + ONE_SIDED_SINE_WIDTH) >= gwlpr[sineband_ind_low + 1]
          ) {
          sineband_ind_high = sineband_ind_low + 1;
      }
    }
*/Band-wise identification - STEP 8{A,B,C}*/
    /* intraframe(26 ms), weighted LB and HB envelope dynamics/variation analysis */
      /* envelope analysis ,
      require at least two HF or two LF bands in the envelope taper/roll-off analysis, otherwise
skip this condition */
    if (non_pure_tone_detect == 0 &&
      (((sineband_ind_high + 2) < Ngrp) ∥
      ((sineband_ind_low − 2) >= 1)
        )
      )
    {
      /* delta tapering-off analysis,
        not sensitive to input bandwidth limitation and levels */
        /* verify that an assumed clean sine does not have any odd LF/HF content indications
          by thresholding the accumulated delta rise in LF/HF side lobes */
      for (i = (sineband_ind_high + 1); i < (Ngrp − 1); i++) {
        tmp = (Xavg[i + 1] + EPS) / (Xavg[i] + EPS);
        tmp_dB = 20.0*log10(tmp);
        if ((Xavg[i] + EPS) > (Xavg[i + 1] + EPS)) {
          tmp_dB = 0;
        }
        tot_inc_HF += scATHFx[i] * tmp_dB; /* i is ATH factor between band i, i+1 based on
Hearing sensitivity */
      }
      /* verify that an assumed clean sine does not have any odd LF content by thresholding the
accumulated LF reverse up tilt */
      for (i = MAX(0, (sineband_ind_low − 1)); i > 0; i−−) {
        tmp = (Xavg[i − 1] + EPS) / (Xavg[i] + EPS);
        tmp_dB = 20.0*log10(tmp); /*log2 constants used in fixed point */
        if ((Xavg[i − 1] + EPS) < (Xavg[i] + EPS)) {
          tmp_dB = 0;
        }
        tot_inc_LF += scATHFx[i − 1] * tmp_dB;
        /* “psycho” scale using i−1 is ATH factor between band i−1, and band i ,
          based on the assumed Hearing sensitivity curve */
      }
      if (tot_inc_HF > 4.5){ /* 4.5 dB in log2 is 0.7474 */
        non_pure_tone_detect |= 0x10; /* still not a pure tone, HF side increase is too great*/
      }
      if (tot_inc_LF > 4.5) {
        /* 4.5 dB limit in 4.5 = 20log10(x) corresponds to limit value 0.7474 in log2(x) */
        non_pure_tone_detect |= 0x20; /* still not a pure tone, accumulated LF side increase is too
great*/
      }
      /* verify that an assumed clean sine does not have any odd LF+HF content by thresholding
the accumulated LF+HF unexpected tilt */
      if ((tot_inc_LF + tot_inc_HF) > 6.0) { /* 6 dB limit in 20log10(x) corresponds to limit
value 1.0 in log2(x) */
        non_pure_tone_detect |= 0x40; /* still not a pure tone, LF+HF side variation/increase is
too great*/
      }
    } /* bands available*/
*/Delivered Output from analysis function which runs STEP 9*/
    return non_pure_tone_detect;
}
```

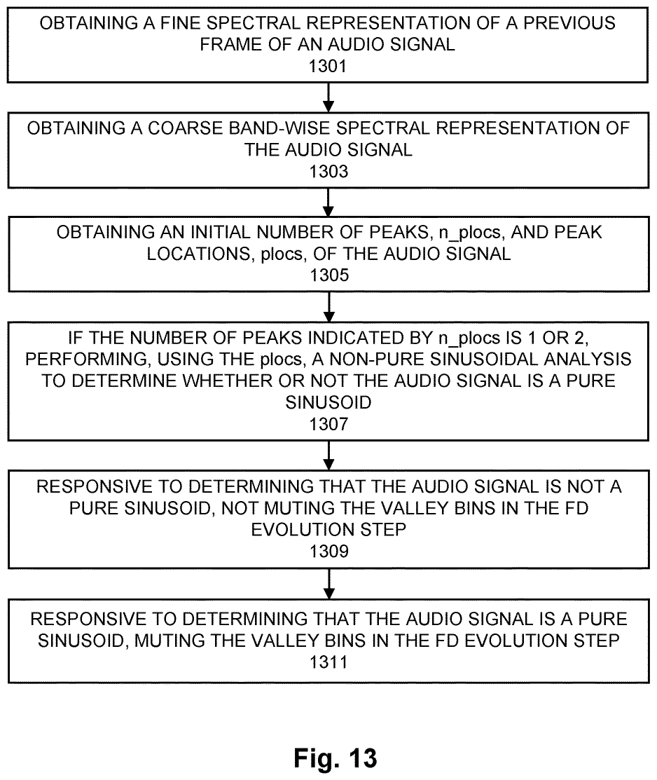

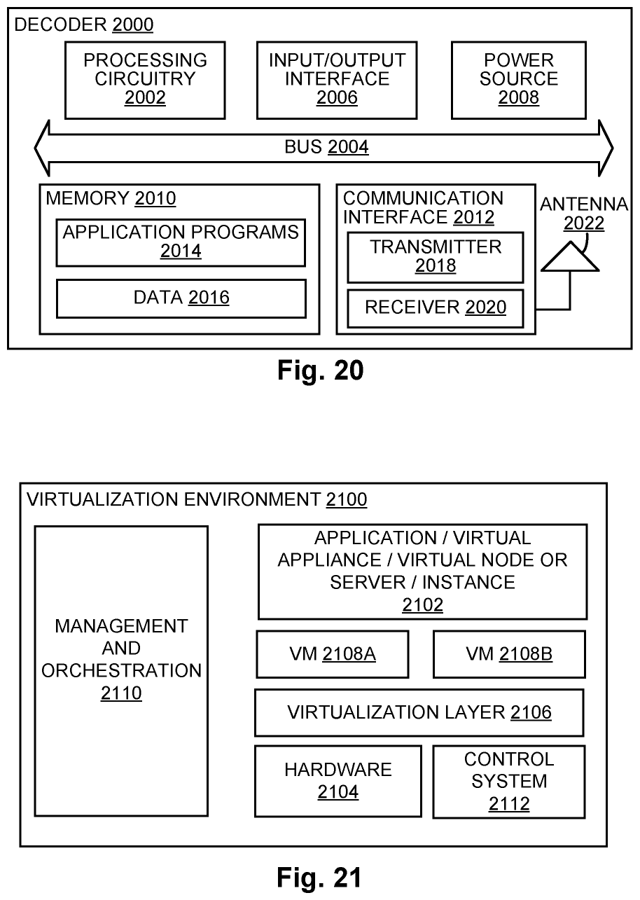

Operations of the decoder 2000 (implemented using the structure of the block diagram of FIG. 20) will now be discussed with reference to the flow chart of FIG. 13 according to some embodiments of inventive concepts. For example, modules may be stored in memory 2010 of FIG. 20, and these modules may provide instructions so that when the instructions of a module are executed by respective decoder processing circuitry 2002, the decoder 2000 performs respective operations of the flow chart.

Turning to FIG. 13, in block 1301, the decoder 2000 obtains a fine spectral representation of a previous frame of an audio signal. In block 1303, the decoder 2000 obtains a coarse band-wise spectral representation of the audio signal.

In block 1305, the decoder 2000 obtains an initial number of peaks, n_plocs, and peak locations, plocs, of the audio signal. In block 1307, the decoder 2000, if the number of peaks indicated by n_plocs is 1 or 2, performs, using the plocs, a non-pure sinusoidal analysis to determine whether or not the audio signal is a pure sinusoid.

In block 1309, the decoder 2000, responsive to determining that the audio signal is not a pure sinusoid, not muting the valley bins in the FD evolution step. In block 1311, the decoder 2000, responsive to determining that the audio signal is a pure sinusoid, mutes the valley bins in the FD evolution step.

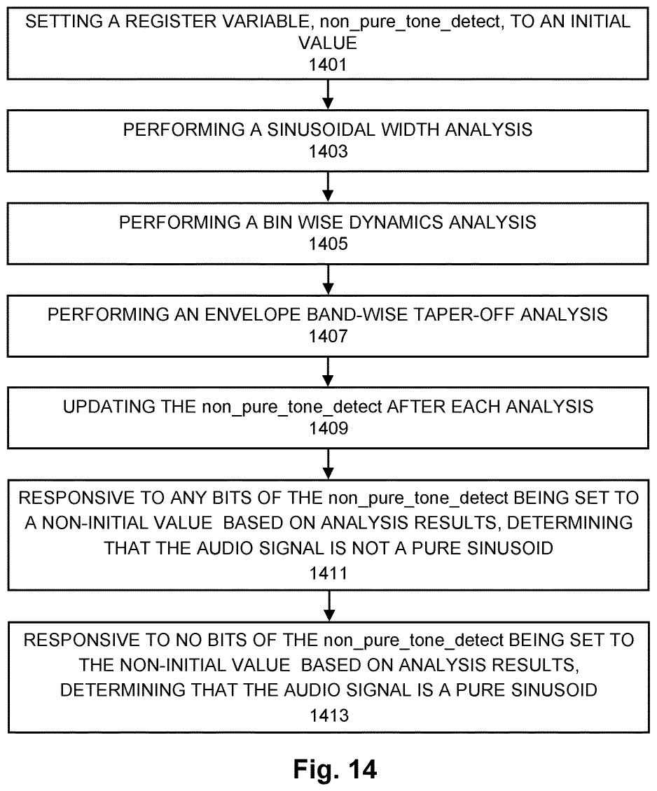

FIG. 14 is a flowchart illustrating operations of the decoder 2000 in performing the non-pure sinusoidal analysis. Turning to FIG. 14, in block 1401, the decoder 2000 sets a register variable, non_pure_tone_detect, to an initial value. For example, the initial value may be zero. In other embodiments, the initial value may be 1.

In block 1403, the decoder 2000 performs a sinusoidal width analysis. In block 1405, the decoder 2000 performs a bin wise dynamics analysis. In block 1407, the decoder 2000 performs an envelope band-wise taper-off analysis. In block 1409, the decoder 2000 updates the non_pure_tone_detect after each analysis.

In block 1411, the decoder 2000, responsive to any bits of the non_pure_tone_detect being set to a non-initial value based on analysis results, determines that the audio signal is not a pure sinusoid. In block 1413, the decoder 2000, responsive to no bits of the non_pure_tone_detect being set to the non-initial value based on analysis results, determines that the audio signal is a pure sinusoid.

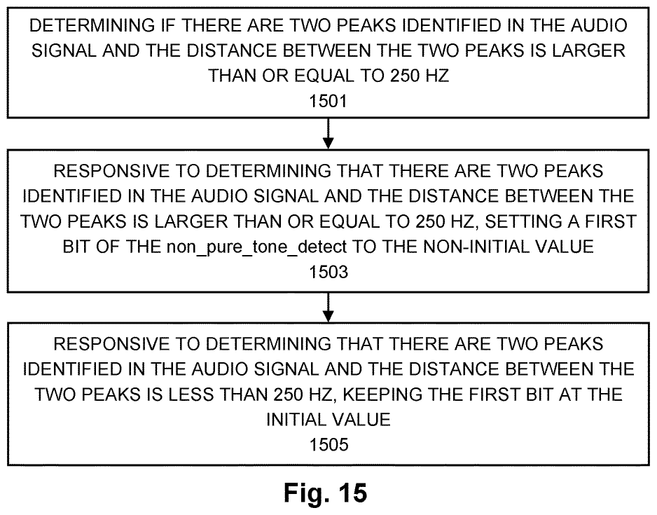

FIG. 15 is a flowchart illustrating operations of the decoder 2000 performing the sinusoidal width analysis. In block 1501, the decoder 2000 determines if there are two peaks identified in the audio signal and the distance between the two peaks is larger than or equal to 250 Hz (or alternatively, if the distance is less than 250 Hz).

In block 1503, the decoder 2000, responsive to determining that there are two peaks identified in the audio signal and the distance between the two peaks is larger than or equal to 250 Hz, sets b0 register of the non_pure_tone_detect to the non-initial value.

In block 1505, the decoder 2000, responsive to determining that there are two peaks identified in the audio signal and the distance between the two peaks is less than 250 Hz, keeps the b0 register of the non_pure_tone_detect at the initial value.

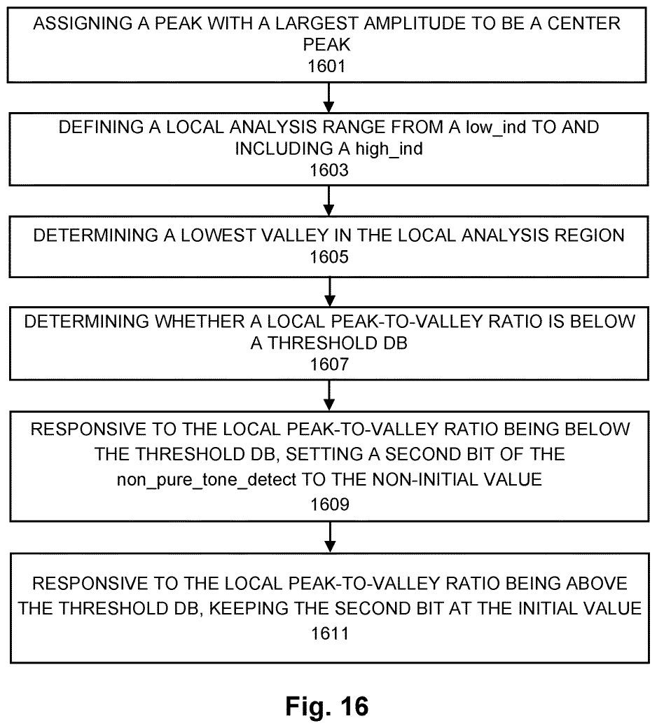

FIG. 16 is a flowchart illustrating operations of the decoder 2000 performing the bin wise dynamics analysis. Turning to FIG. 16, in block 1601, the decoder 2000 assigns a peak with a largest amplitude to be a center peak. This is done when there are two peaks. This block is optional when there is only one peak.

In block 1603, the decoder 2000 defines a local analysis range from a low_ind to and including a high_ind. In some embodiments, the range is defined according to

$$low ind = MAX ( 62. 5 , ( plocs [ tone\_ind ] * 62.5 ) - 3 12.5 Hz ) / 62.5 ; and$$

$$hign\_ind = MIN ( Fs / 2 - 62.5 , ( plocs [ tone\_ind ] * 62.5 ) + 3 12.5 Hz ) / 62.5$$

In block 1605, the decoder 2000 determines a lowest valley in the local analysis region. In some embodiments, the lowest valley is determined in accordance with

$$valley\_ind = {arg min}_{k = lo {w}_{i n d} … high \_ ind} ( Xabs ( k ) ) .$$

In block 1607, the decoder 2000 determines whether a local peak-to-valley ratio is below a threshold dB. In some embodiments, the threshold dB is 24 dB, and the peak-to-valley ratio is determined according to:

$$\frac{Xabs ( plocs ( tone\_ind ) )}{Xabs ( valley\_ind )}$$

In block 1609, the decoder 2000, responsive to the local peak-to-valley ratio being below the threshold dB, sets a b1 register of the non_pure_tone_detect to the non-initial value.

In block 1611, the decoder 2000, responsive to the local peak-to-valley ratio being above the threshold dB, keeps the b1 register at the initial value.

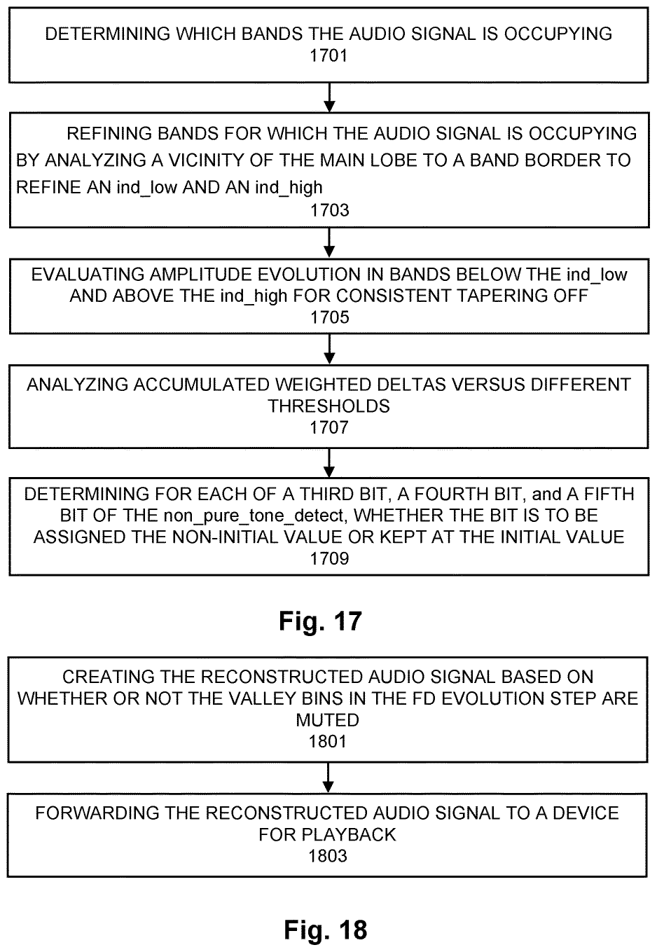

FIG. 17 is a flowchart illustrating operations of the decoder 2000 performing the envelope band-wise taper-off analysis. Turning to FIG. 17, in block 1701, the decoder 2000 determines which bands the audio signal (i.e., the assumed single sinusoid) is occupying. In some embodiments, the decoder 2000 determines which band the audio signal is occupying according to

$$ind\_pre ( b ) = \{ \begin{matrix}b , & plocs [ tone\_ind ] \geq gwlpr ( b + 1 ) , b ∈ 0 … ( Ngrp - 1 ) \\ - 1 & otherwise\end{matrix}$$

$$ind\_low = {arg max}_{b = 0 … ( Ngrp - 1 )} ( ind\_pre ( b ) )$$

$$ind\_high = ind\_low$$

In block 1703, the decoder 2000 refines bands for which the audio signal is occupying by analyzing a vicinity of the main lobe to a band border to refine the ind_low and the ind_high. In some embodiments, the decoder 2000 refines the bands according to

$$ind\_low = \{ \begin{matrix}ind\_high - 1 , & \begin{matrix}ind\_high > 1 \\ AND \\ ( plocs [ tone\_ind ] * 62.5 - 250 Hz ) \geq \\ gwlpr ( ind\_high + 1 )\end{matrix} \\ ind\_low , & otherwise\end{matrix}$$

$$and$$

$$ind\_high = \{ \begin{matrix}ind\_low + 1 , & \begin{matrix}ind\_low > ( Ngrp - 1 ) \\ AND \\ ( plocs [ tone\_ind ] * 62.5 + 250 Hz ) \geq \\ gwlpr ( ind\_low + 1 )\end{matrix} \\ ind\_high , & otherwise\end{matrix}$$

In block 1705, the decoder 2000 evaluates amplitude evolution in bands below ind_low and above ind_high for consistent tapering off. In some embodiments, the decoder 2000 evaluates the amplitude evolution according to

$$tot\_inc \_HF = {\sum }_{i = ind \_ high + 1}^{( Ngrp - 1 )} scATH ( i ) * max ( 0. dB , 20 log 10 ( \frac{X a v g ( i + 1 )}{X a v g ( i )} ) )$$

$$tot\_inc \_LF = {\sum }_{i = max ( 0 , ind \_ low - 1 )}^{0} s c A T H ( i - 1 ) * max ( 0. dB , 20 log 10 ( \frac{X a v g ( i - 1 )}{X a v g ( i )} ) )$$

where scATH(i) is given by:

$$float scATH [ Ngrp - 1 ] = \{ 0.4554443359375 , 0.930755615234375 , 0.97308349609375 , \\ 0.999969482481875 , 0.90850830078125 , 0.775665283203125 , 0.5 \} .$$

In block 1707, the decoder 2000 analyzes accumulated weighted deltas versus thresholds according to

$$b 4 = \{ \begin{matrix}1 , & tot\_incHF > 4.5 dB \\ 0 , & otherwise\end{matrix}$$

$$b 5 = \{ \begin{matrix}1 , & tot\_inc \_LF > 4.5 dB \\ 0 , & otherwise\end{matrix}$$

$$b 6 = \{ \begin{matrix}1 , & tot\_inc \_LF + tot\_incHF > 6. dB \\ 0 , & otherwise\end{matrix} .$$

In block 1709, the decoder 2000 determines for each of the b4, b5, and b6 registers, whether the register is to be assigned the non-initial value or kept at the initial value. In some embodiments, the decoder 2000 determines whether the register is to be assigned the non-initial value or kept at the initial value according to:

$$for b 4 : assigning b 4 the non - initial value if tot\_incHF > 4.5 dB ;$$

$$and keeping b 4 at the initial value if tot\_incHF \leq 4.5 dB$$

$$for b 5 : assigning b 5 the non - initial value if tot\_inc \_LF > 4.5 dB ;$$

$$and keeping b 5 at the initial value if tot\_inc \_LF \leq 4.5 dB$$

$$for b 6 : assigning b 6 the non - initial value if tot\_inc \_LF + tot\_incHF > 6. dB ;$$

$$and keeping b 6 at the initial value if tot\_inc \_LF + tot\_incHF \leq 6. dB .$$

FIG. 18 is a flowchart illustrating operations the decoder 2000 performs in creating the reconstructed audio signal. Turning to FIG. 18, in block 1801, the decoder 2000 creates the reconstructed audio signal based on whether or not the valley bins in the FD evolution step are muted. In block 1803, the decoder 2000 forwards the reconstructed audio signal to a device for playback.

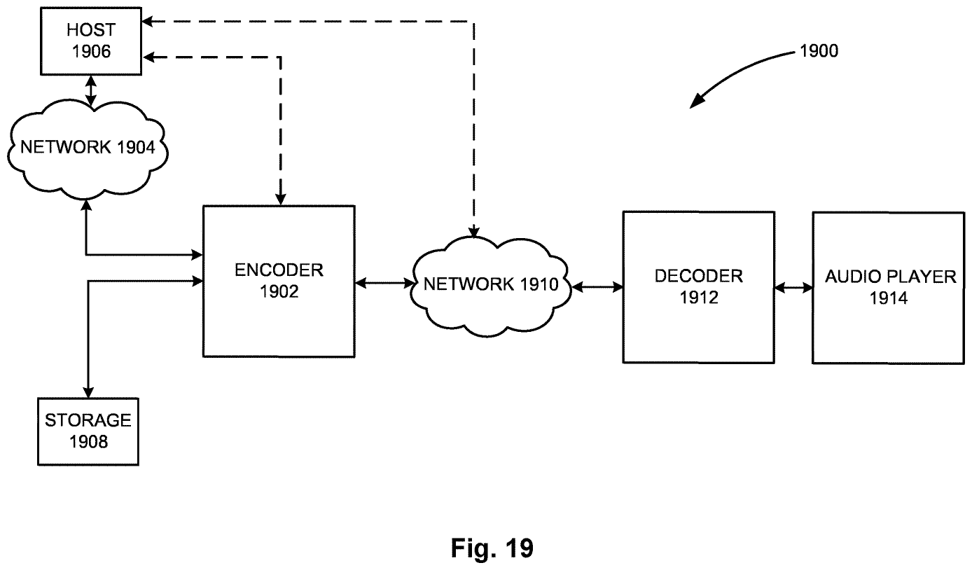

An operating environment in which the various embodiments may be implemented shall now be described. FIG. 19 illustrates an example of an operating environment in which the various embodiments of the present disclosure may be implemented. Turning to FIG. 19, in the example operating environment 1900, the encoder 1902 receives data, such as an audio file and in some cases metadata, to be encoded from an entity through network 1904, such as a host 1906, and/or from storage 1908. In some embodiments, the host 1906 may communicate directly to the encoder 1902. The encoder 1902 encodes the audio file as well as the scene description via metadata and either stores the encoded information in storage 1908 or transmits the encoded audio file to a decoder 1912 via network 1910. The encoder 1902 and the host 1906 have at least processing circuitry, memory, and a communication interface for communicating with other encoders, hosts, and decoders including decoder 1912. The decoder 1912 decodes the audio file and the scene description in the metadata and transmits the decoded audio file to an audio player 1914 for playback. The audio player 1914 may be or be comprised in a user equipment, a terminal, a mobile phone, and the like. In other embodiments, the host 1906 may transmit encoded audio files to the decoder 1912 via network 1910. The decoder 1912 may be the decoder 200, the decoder 2000, and the like.

FIG. 20 shows a decoder 2000 in accordance with some embodiments. As used herein, a decoder refers to a device capable, configured, arranged and/or operable to decoder audio signals and communicate with network nodes and/or other decoders and encoders. Examples of a decoder include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc.

The decoder 2000 includes processing circuitry 2002 that is operatively coupled via a bus 2004 to an input/output interface 2006, a power source 2008, a memory 2010, a communication interface 2012, and/or any other component, or any combination thereof. Certain decoders may utilize all or a subset of the components shown in FIG. 20. The level of integration between the components may vary from one decoder to another decoder. Further, certain decoders may contain multiple instances of a component, such as multiple processors, memories, transceivers, transmitters, receivers, etc.

The processing circuitry 2002 is configured to process instructions and data and may be configured to implement any sequential state machine operative to execute instructions stored as machine-readable computer programs in the memory 2010. The processing circuitry 2002 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 2002 may include multiple central processing units (CPUs).

In the example, the input/output interface 2006 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the decoder 2000. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 2008 is structured as a battery or battery pack. Other types of power sources, such as an external power source (e.g., an electricity outlet), photovoltaic device, or power cell, may be used. The power source 2008 may further include power circuitry for delivering power from the power source 2008 itself, and/or an external power source, to the various parts of the decoder 2000 via input circuitry or an interface such as an electrical power cable. Delivering power may be, for example, for charging of the power source 2008. Power circuitry may perform any formatting, converting, or other modification to the power from the power source 2008 to make the power suitable for the respective components of the decoder 2000 to which power is supplied.

The memory 2010 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 2010 includes one or more application programs 2014, such as an operating system, web browser application, a widget, gadget engine, or other application, and corresponding data 2016. The memory 2010 may store, for use by the decoder 2000, any of a variety of various operating systems or combinations of operating systems.

The memory 2010 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 2010 may allow the decoder 2000 to access instructions, application programs and the like, stored on transitory or non-transitory memory media, to off-load data, or to upload data. An article of manufacture, such as one utilizing a communication system may be tangibly embodied as or in the memory 2010, which may be or comprise a device-readable storage medium.

The processing circuitry 2002 may be configured to communicate with an access network or other network using the communication interface 2012. The communication interface 2012 may comprise one or more communication subsystems and may include or be communicatively coupled to an antenna 2022. The communication interface 2012 may include one or more transceivers used to communicate, such as by communicating with one or more remote transceivers of another device capable of wireless communication (e.g., another decoder or a network node in an access network). Each transceiver may include a transmitter 2018 and/or a receiver 2020 appropriate to provide network communications (e.g., optical, electrical, frequency allocations, and so forth). Moreover, the transmitter 2018 and receiver 2020 may be coupled to one or more antennas (e.g., antenna 2022) and may share circuit components, software, or firmware, or alternatively be implemented separately.

In the illustrated embodiment, communication functions of the communication interface 2012 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

FIG. 21 is a block diagram illustrating a virtualization environment 2100 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 2100 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 2102 (which may alternatively be called software instances, virtual appliances, network functions, virtual nodes, virtual network functions, etc.) are run in the virtualization environment 2100 to implement some of the features, functions, and/or benefits of some of the embodiments disclosed herein.

Hardware 2104 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 2106 (also referred to as hypervisors or virtual machine monitors (VMMs)), provide VMs 2108A and 2108B (one or more of which may be generally referred to as VMs 2108), and/or perform any of the functions, features and/or benefits described in relation with some embodiments described herein. The virtualization layer 2106 may present a virtual operating platform that appears like networking hardware to the VMs 2108.

The VMs 2108 comprise virtual processing, virtual memory, virtual networking or interface and virtual storage, and may be run by a corresponding virtualization layer 2106. Different embodiments of the instance of a virtual appliance 2102 may be implemented on one or more of VMs 2108, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 2108 may be a software implementation of a physical machine that runs programs as if they were executing on a physical, non-virtualized machine. Each of the VMs 2108, and that part of hardware 2104 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 2108 on top of the hardware 2104 and corresponds to the application 2102.

Hardware 2104 may be implemented in a standalone network node with generic or specific components. Hardware 2104 may implement some functions via virtualization. Alternatively, hardware 2104 may be part of a larger cluster of hardware (e.g., such as in a data center or CPE) where many hardware nodes work together and are managed via management and orchestration 2110, which, among others, oversees lifecycle management of applications 2102. In some embodiments, hardware 2104 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 2112 which may alternatively be used for communication between hardware nodes and radio units.

### EMBODIMENTS

1. A method to determine whether or not to mute valley bins in a frequency domain, FD, evolution step of a packet loss concealment in a phase error concealment unit in a decoder (200, 1912, 2000), the method comprising:
obtaining (1301) a fine spectral representation of a previous frame of an audio signal;
obtaining (1303) a coarse band-wise spectral representation of the audio signal;
obtaining (1305) an initial number of peaks, n_plocs, and peak locations of the audio signal;
if the number of peaks indicated by n_plocs is 1 or 2, performing (1307) a non-pure sinusoidal analysis to determine whether or not the audio signal is a pure sinusoid;
responsive to determining that the audio signal is not a pure sinusoid, not muting (1309) the valley bins in the FD evolution step; and
responsive to determining that the audio signal is a pure sinusoid, muting (1311) the valley bins in the FD evolution step.

2. The method of Embodiment 1, wherein performing the non-pure sinusoidal analysis comprises:
setting (1401) a register variable, non_pure_tone_detect, to an initial value;
performing (1403) a sinusoidal width analysis;
performing (1405) a bin wise dynamics analysis;
performing (1407) an envelope band-wise taper-off analysis;
updating (1409) the non_pure_tone_detect after each analysis;
responsive to any bits of the non_pure_tone_detect being set to a non-initial value based on analysis results, determining (1411) that the audio signal is not a pure sinusoid; and
responsive to no bits of the non_pure_tone_detect being set to a non-initial value based on analysis results, determining (1413) that the audio signal is a pure sinusoid.

3. The method of Embodiment 2, wherein performing the sinusoidal width analysis comprises:
determining (1501) if there are two peaks identified in the audio signal and the distance between the two peaks is larger than or equal to 250 Hz; and
responsive to determining that there are two peaks identified in the audio signal and the distance between the two peaks is larger than or equal to 250 Hz, setting (1503) a b0 register of the non_pure_tone_detect to the non-initial value; and
responsive to determining that there are two peaks identified in the audio signal and the distance between the two peaks is less than 250 Hz, keeping (1505) the b0 register at the initial value.

4. The method of any of Embodiments 2-3, wherein performing the bin wise dynamics analysis comprises:
assigning (1601) a peak with a largest amplitude to be a center peak;
defining (1603) a local analysis range from a low_ind to and including a high_ind;
determining (1605) a lowest valley in the local analysis region;
determining (1607) whether a local peak-to-valley ratio is below a threshold dB;
responsive to the local peak-to-valley ratio being below the threshold dB, setting (1609) a b1 register of the non_pure_tone_detect to the non-initial value; and
responsive to the local peak-to-valley ratio being above the threshold dB, keeping (1611) the b1 register at the initial value.

5. The method of Embodiment 4, wherein the local analysis region is defined according to

$$low ind = MAX ( 62 \text{.5} , ( plocs [ tone\_ind ] * 62.5 ) - 312.5 Hz ) / 62.5 ; and$$

$$high\_ind = MIN ( Fs / 2 - 62.5 , ( plocs [ tone\_ind ] * 62.5 ) + 312.5 Hz ) / 62.5 ;$$

wherein the lowest valley in the local analysis region is established as

$$valley\_ind = {arg min}_{k = {low}_{ind} … high \_ ind} ( X abs ( k ) ) ; and$$

wherein the threshold dB is 24 dB and the local peak-to-valley region is defined according to:

$$\frac{X abs ( plocs [ tone\_ind ] )}{X abs ( valley\_ind )} .$$

6. The method of any of Embodiments 2-5, wherein performing the envelope band-wise taper-off analysis comprises:
determining (1701) which bands the audio signal is occupying;
refining (1703) bands for which the audio signal is occupying by analyzing a vicinity of the main lobe to a band border to refine an ind_low and an ind_high;
evaluating (1705) amplitude evolution in bands below ind_low and above ind_high for consistent tapering off;
analyzing (1707) accumulated weighted deltas versus thresholds; and
determining (1709) for each of b4, b5, and b6 registers, whether the register is to be assigned the non-initial value or kept at the initial value.

7. The method of Embodiment 6, wherein determining which band the audio signal is occupying comprises determining which band the audio signal is occupying according to

$$ind\_pre ( b ) = \{ \begin{matrix}b & , plocs [ tone\_ind ] \geq gwlpr ( b + 1 ) & , b ∈ 0 … ( Ngrp - 1 ) \\ - 1 & otherwse & \end{matrix}$$

$$ind\_low = {arg max}_{b = 0 … ( Ngrp - 1 )} ( ind\_pre ( b ) )$$

$$ind\_high = ind\_low .$$

8. The method of any of Embodiments 6-7, wherein refining the bands comprising refining the bands according to

$$ind\_low = \{ \begin{matrix} & ind\_high > 1 \\ ind\_high - 1 , & AND \\ & ( plocs [ tone\_ind ] * 62.5 - 250 Hz ) \geq gwlpr ( ind\_high + 1 ) \\ ind\_low , & otherwise\end{matrix}$$

$$and$$

$$ind\_high = \{ \begin{matrix} & ind\_low < ( Ngrp - 1 ) \\ ind\_low + 1 , & AND \\ & ( plocs [ tone\_ind ] * 62.5 + 250 Hz ) \geq gwlpr ( ind\_low + 1 ) \\ ind\_high , & otherwise\end{matrix} .$$

9. The method of any of Embodiments 6-8, wherein evaluating the amplitude evolution in bands below ind_low and above ind_high comprises evaluating the amplitude evolution according to

$$tot\_inc \_HF = {\sum }_{i = ind \_ high + 1}^{( Ngrp - 1 )} scATH ( i ) * max ( 0. dB , 20 log 10 ( \frac{X a v g ( i + 1 )}{X a v g ( i )} ) )$$

$$tot\_inc \_LF = {\sum }_{i = max ( 0 , ind \_ low - 1 )}^{0} s c A T H ( i - 1 ) * max ( 0. dB , 20 log 10 ( \frac{X a v g ( i - 1 )}{X a v g ( i )} ) )$$

where scATH(i) is given by: float scATH[Ngrp−1]={0.455444335937500, 0.930755615234375, 0.973083496093750, 0.999969482421875, 0.908508300781250, 0.775665283203125, 0.5}.

10. The method of any of Embodiments 6-9, wherein analyzing the accumulated weighted deltas versus thresholds comprises analyzing the accumulated weighted deltas versus thresholds according to

$$b 4 = \{ \begin{matrix}1 , & tot\_incHF > 4.5 dB \\ 0 , & otherwise\end{matrix}$$

$$b 5 = \{ \begin{matrix}1 , & tot\_inc \_LF > 4.5 dB \\ 0 , & otherwise\end{matrix}$$

$$b 6 = \{ \begin{matrix}1 , & tot\_inc \_LF + tot\_incHF > 6. dB \\ 0 , & otherwise\end{matrix} .$$

11. The method of Embodiment 10, wherein determining for each of b4, b5, and b6 registers, whether the register is to be assigned the non-initial value or kept at the initial value comprises

$$for b 4 : assigning b 4 the non - initial value if tot\_incHF > 4.5 dB ;$$

$$and keeping b 4 at the initial value if tot\_incHF \leq 4.5 dB$$

$$for b 5 : assigning b 5 the non - initial value if tot\_inc \_LF > 4.5 dB ;$$

$$and keeping b 5 at the initial value if tot\_inc \_LF \leq 4.5 dB$$

$$for b 6 : assigning b 6 the non - initial value if tot\_inc \_LF + tot\_incHF > 6. dB ;$$

$$and keeping b 6 at the initial value if tot\_inc \_LF + tot\_incHF \leq 6. dB .$$

12. The method of any of Embodiments 1-11, wherein the packet loss concealment creates a reconstructed audio signal to replace an audio signal of a bad frame, the method further comprising:
creating (1801) the reconstructed audio signal based on whether or not the valley bins in the FD evolution step are muted; and
forwarding (1803) the reconstructed audio signal to a device for playback.

13. A decoder (200, 1912, 2000, 2102) adapted to determine whether or not to mute valley bins in a frequency domain, FD, evolution step of a packet loss concealment in a phase error concealment unit in the decoder (200, 1912, 2000, 2102), the decoder (200, 1912, 2000, 2102) adapted to:
obtain (1301) a fine spectral representation of a previous frame of an audio signal;
obtain (1303) a coarse band-wise spectral representation of the audio signal;
obtain (1305) an initial number of peaks, n_plocs, and peak locations of the audio signal;
if the number of peaks indicated by n_plocs is 1 or 2, perform (1307) a non-pure sinusoidal analysis to determine whether or not the audio signal is a pure sinusoid;
responsive to determining that the audio signal is not a pure sinusoid, not mute (1309) the valley bins in the FD evolution step; and
responsive to determining that the audio signal is a pure sinusoid, mute (1311) the valley bins in the FD evolution step.

14. The decoder (200, 1912, 2000, 2102) of Embodiment 13, wherein in performing the non-pure sinusoidal analysis, the decoder (200, 1912, 2000, 2102) is further adapted to:
set (1401) a register variable, non_pure_tone_detect, to an initial value;
perform (1403) a sinusoidal width analysis;
perform (1405) a bin wise dynamics analysis;
perform (1407) an envelope band-wise taper-off analysis;
update (1409) the non_pure_tone_detect after each analysis;
responsive to any bits of the non_pure_tone_detect being set to a non-initial value based on analysis results, determine (1411) that the audio signal is not a pure sinusoid; and
responsive to no bits of the non_pure_tone_detect being set to a non-initial value based on analysis results, determine (1413) that the audio signal is a pure sinusoid.

15. The decoder (200, 1912, 2000, 2102) of Embodiment 14, wherein in performing the sinusoidal width analysis, the decoder (200, 1912, 2000, 2102) is further adapted to:
determine (1501) if there are two peaks identified in the audio signal and the distance between the two peaks is larger than or equal to 250 Hz; and
responsive to determining that there are two peaks identified in the audio signal and the distance between the two peaks is larger than or equal to 250 Hz, set (1503) a b0 register of the non_pure_tone_detect to the non-initial value; and
responsive to determining that there are two peaks identified in the audio signal and the distance between the two peaks is less than 250 Hz, keep (1505) the b0 register at the initial value.

16. The decoder (200, 1912, 2000, 2102) of any of Embodiments 14-15, wherein in performing the bin wise dynamics analysis, the decoder (200, 1912, 2000, 2102) is further adapted to:
assign (1601) a peak with a largest amplitude to be a center peak;
define (1603) a local analysis range from a low_ind to and including a high_ind;
determine (1605) a lowest valley in the local analysis region;
determine (1607) whether a local peak-to-valley ratio is below a threshold dB;
responsive to the local peak-to-valley ratio being below the threshold dB, set (1609) a b1 register of the non_pure_tone_detect to the non-initial value; and
responsive to the local peak-to-valley ratio being above the threshold dB, keep (1611) the b1 register at the initial value.

17. The decoder (200, 1912, 2000, 2102) of Embodiment 16, wherein the local analysis region is defined according to

$$low ind = MAX ( 62 \text{.5} , ( plocs [ tone\_ind ] * 62.5 ) - 312.5 Hz ) / 62.5 ; and$$

$$high\_ind = MIN ( Fs / 2 - 62.5 , ( plocs [ tone\_ind ] * 62.5 ) + 312.5 Hz ) / 62.5 ;$$

wherein the lowest valley in the local analysis region is established as

$$valley\_ind = {arg min}_{k = {low}_{ind} … high \_ ind} ( X abs ( k ) ) ; and$$

wherein the threshold dB is 24 dB and the local peak-to-valley region is defined according to:

$$\frac{X abs ( plocs [ tone\_ind ] )}{X abs ( valley\_ind )} .$$

18. The decoder (200, 1912, 2000, 2102) of any of Embodiments 14-17, wherein in performing the envelope band-wise taper-off analysis, the decoder (200, 1912, 2000, 2102) is adapted to:
determining (1701) which bands the audio signal is occupying;
refining (1703) bands for which the audio signal is occupying by analyzing a vicinity of the main lobe to a band border to refine an ind_low and an ind_high;
evaluating (1705) amplitude evolution in bands below ind_low and above ind_high for consistent tapering off;
analyzing (1707) accumulated weighted deltas versus thresholds; and
determining (1709) for each of b4, b5, and b6 registers, whether the register is to be assigned the non-initial value or kept at the initial value.

19. The decoder (200, 1912, 2000, 2102) of Embodiment 18, wherein in determining which band the audio signal is occupying, the decoder (200, 1912, 2000, 2102) is adapted to determine which band the audio signal is occupying according to

$$ind\_pre ( b ) = \{ \begin{matrix}b & , plocs [ tone\_ind ] \geq gwlpr ( b + 1 ) , b ∈ 0 … ( Ngrp - 1 ) \\ - 1 & otherwise\end{matrix}$$

$$ind\_low = {arg max}_{b = 0 … ( Ngrp - 1 )} ( ind\_pre ( b ) )$$

$$ind\_high = ind\_low$$

20. The decoder (200, 1912, 2000, 2102) of any of Embodiments 18-19, wherein in refining the bands, the decoder (200, 1912, 2000, 2102) is adapted to refine the bands according to

$$ind\_low = \{ \begin{matrix} & ind\_high > 1 \\ ind\_high - 1 , & AND \\ & ( plocs [ tone\_ind ] * 62.5 - 250 Hz ) \geq gwlpr ( ind\_high + 1 ) \\ ind\_low , & otherwise\end{matrix}$$

$$and$$

$$ind\_high = \{ \begin{matrix} & ind\_low < ( Ngrp - 1 ) \\ ind\_low + 1 , & AND \\ & ( plocs [ tone\_ind ] * 62.5 + 250 Hz ) \geq gwlpr ( ind\_low + 1 ) \\ ind\_high , & otherwise\end{matrix}$$

21. The decoder (200, 1912, 2000, 2102) of any of Embodiments 18-20, wherein in evaluating the amplitude evolution in bands below ind_low and above ind_high, the decoder (200, 1912, 2000, 2102) is further adapted to evaluate the amplitude evolution according to

$$tot\_inc \_HF = {\sum }_{i = ind \_ high + 1}^{( Ngrp - 1 )} s c A T H ( i ) * max ( 0. dB , 20 log 10 ( \frac{X a v g ( i + 1 )}{X a v g ( i )} ) )$$

$$tot\_inc \_LF = {\sum }_{i = max ( 0 , ind \_ low - 1 )}^{0} s c A T H ( i - 1 ) * max ( 0. dB , 20 log 10 ( \frac{X a v g ( i - 1 )}{X a v g ( i )} ) )$$

where scATH(i) is given by: float scATH[Ngrp−1]={0.455444335937500, 0.930755615234375, 0.973083496093750, 0.999969482421875, 0.908508300781250, 0.775665283203125, 0.5}.

22. The decoder (200, 1912, 2000, 2102) of any of Embodiments 18-21, wherein in analyzing the accumulated weighted deltas versus thresholds, the decoder (200, 1912, 2000, 2102) is adapted to analyze the accumulated weighted deltas versus thresholds according to

$$b 4 = \{ \begin{matrix}1 , & tot\_incHF > 4.5 dB \\ 0 , & otherwise\end{matrix}$$

$$b 5 = \{ \begin{matrix}1 , & tot\_inc \_LF > 4.5 dB \\ 0 , & otherwise\end{matrix}$$

$$b 6 = \{ \begin{matrix}1 , & tot\_inc \_LF + tot\_incHF > 6. dB \\ 0 , & otherwise\end{matrix}$$

23. The decoder (200, 1912, 2000, 2102) of Embodiment 22, wherein in determining for each of b4, b5, and b6 registers, whether the register is to be assigned the non-initial value or kept at the initial value, the decoder (200, 1912, 2000, 2102) is further adapted to:

$$for b 4 : assigning b 4 the non - initial value if tot\_incHF > 4.5 dB ;$$

$$and keeping b 4 at the initial value if tot\_incHF \leq 4.5 dB$$

$$for b 5 : assigning b 5 the non - initial value if tot\_inc \_LF > 4.5 dB ;$$

$$and keeping b 5 at the initial value if tot\_inc \_LF \leq 4.5 dB$$

$$for b 6 : assigning b 6 the non - initial value if tot\_inc \_LF + tot\_incHF > 6. dB ;$$

$$and keeping b 6 at the initial value if tot\_inc \_LF + tot\_incHF \leq 6. dB .$$

24. The decoder (200, 1912, 2000, 2102) of any of Embodiments 13-23, wherein the packet loss concealment creates a reconstructed audio signal to replace an audio signal of a bad frame, wherein the decoder (200, 1912, 2000, 2102) is further adapted to:
create (1801) the reconstructed audio signal based on whether or not the valley bins in the FD evolution step are muted; and
forward (1803) the reconstructed audio signal to a device for playback.

25. A decoder (200, 1912, 2000, 2102) comprising:
processing circuitry (2002); and
memory (2010) coupled with the processing circuitry, wherein the memory includes instructions that when executed by the processing circuitry causes the decoder (200, 1912, 2000, 2102) to perform operations according to any of Embodiments 1-12.

26. A computer program comprising program code to be executed by processing circuitry (2002) of a decoder (200, 1912, 2000, 2102), whereby execution of the program code causes the decoder (200, 1912, 2000, 2102) to perform operations according to any of Embodiments 1-12.

27. A computer program product comprising a non-transitory storage medium including program code to be executed by processing circuitry (2002) of a decoder (200, 1912, 2000, 2102), whereby execution of the program code causes the decoder (200, 1912, 2000, 2102) to perform operations according to any of Embodiments 1-12.

1. A method to determine whether or not to mute valley bins in a frequency domain, FD, evolution step of a packet loss concealment in a decoder, the method comprising:
obtaining an initial number of peaks, n_plocs, and peak locations, plocs, of the audio signal;
if the number of peaks indicated by n_plocs is 1 or 2, performing, using the plocs, a non-pure sinusoidal analysis to determine whether or not the audio signal is a pure sinusoid;
responsive to determining that the audio signal is not a pure sinusoid, not muting the valley bins in the FD evolution step; and
responsive to determining that the audio signal is a pure sinusoid, muting the valley bins in the FD evolution step.

2. The method of claim 1, wherein performing the non-pure sinusoidal analysis comprises:
setting a register variable, non_pure_tone_detect, to an initial value;
performing a sinusoidal width analysis;
performing a bin wise dynamics analysis;
performing an envelope band-wise taper-off analysis;
updating the non_pure_tone_detect after each analysis;
responsive to any bits of the non_pure_tone_detect being set to a non-initial value based on analysis results, determining that the audio signal is not a pure sinusoid; and
responsive to no bits of the non_pure_tone_detect being set to a non-initial value based on analysis results, determining that the audio signal is a pure sinusoid.

3. The method of claim 2, wherein performing the sinusoidal width analysis comprises:
determining if there are two peaks identified in the audio signal and the distance between the two peaks is larger than or equal to 250 hertz (Hz); and
responsive to determining that there are two peaks identified in the audio signal and the distance between the two peaks is larger than or equal to 250 Hz, setting a first bit of the non_pure_tone_detect to the non-initial value; and
responsive to determining that there are two peaks identified in the audio signal and the distance between the two peaks is less than 250 Hz, keeping the first bit at the initial value.

4. The method of claim 2, wherein performing the bin wise dynamics analysis comprises:
assigning a peak with a largest amplitude to be a center peak;
defining a local analysis range from a low_ind to and including a high_ind;
determining a lowest valley in the local analysis region;
determining whether a local peak-to-valley ratio is below a threshold decibel, dB;
responsive to the local peak-to-valley ratio being below the threshold dB, setting a second bit of the non_pure_tone_detect to the non-initial value; and
responsive to the local peak-to-valley ratio being above the threshold dB, keeping the second bit at the initial value.

5. The method of claim 4, wherein the local analysis region is defined according to a first formula for computing the low_ind and a second formula for computing the high_ind, wherein the first formula determines the maximum value between 62.5 and a result computed by multiplying a center peak value by 62.5 and subtracting 312.5 hertz and then divides the maximum value by 62.5 and the second formula determines a minimum value between half of a sampling frequency value minus 62.5 and a result computed by multiplying a center peak value by 62.5 and adding 312.5 Hz, then divides the minimum value by 62.5, and wherein the lowest valley in the local analysis region is established by determining a minimum value from the absolute amplitude values of the bins of the local analysis range; and wherein the threshold dB is less than 24 dB and the local peak-to-valley region is defined by dividing the absolute value of the center peak by the absolute value of the lowest valley.

6. The method of claim 2, wherein performing the envelope band-wise taper-off analysis comprises:
determining which bands the audio signal is occupying;
refining bands for which the audio signal is occupying by analyzing a vicinity of the main lobe to a band border to refine an ind_low, and an ind_high;
evaluating amplitude evolution in bands below the ind_low and above the ind_high for consistent tapering off;
analyzing accumulated weighted deltas versus thresholds; and
determining for each of a third bit, a fourth bit, and a fifth bit of the non_pure_tone_detect, whether the bit is to be assigned the non-initial value or kept at the initial value.

7. The method of claim 6, wherein determining which band the audio signal is occupying comprises determining which band the audio signal is occupying according to:
$$ind\_pre ( b ) = \{ \begin{matrix}b & , plocs [ tone\_ind ] \geq gwlpr ( b + 1 ) , b ∈ 0 … ( Ngrp - 1 ) \\ - 1 & otherwise\end{matrix}$$
$$ind\_low = {arg max}_{b = 0 … ( Ngrp - 1 )} ( ind\_pre ( b ) )$$
$$ind\_high = ind\_low .$$

8. The method of claim 6, wherein refining the bands comprising refining the bands according to:
$$ind\_low = \{ \begin{matrix} & ind\_high > 1 \\ ind\_high - 1 , & AND \\ & ( plocs [ tone\_ind ] * 62.5 - 250 Hz ) \geq gwlpr ( ind\_high + 1 ) \\ ind\_low , & otherwise\end{matrix}$$
$$and$$
$$ind\_high = \{ \begin{matrix} & ind\_low < ( Ngrp - 1 ) \\ ind\_low + 1 , & AND \\ & ( plocs [ tone\_ind ] * 62.5 + 250 Hz ) \geq gwlpr ( ind\_low + 1 ) \\ ind\_high , & otherwise\end{matrix} .$$

9. The method of claim 6, wherein evaluating the amplitude evolution in bands below the ind_low and above the ind_high comprises evaluating the amplitude evolution according to
$$tot\_inc \_HF = {\sum }_{i = ind \_ high + 1}^{( Ngrp - 1 )} s c A T H ( i ) * max ( 0. dB , 20 log 10 ( \frac{X a v g ( i + 1 )}{X a v g ( i )} ) )$$
$$tot\_inc \_LF = {\sum }_{i = max ( 0 , ind \_ low - 1 )}^{0} s c A T H ( i - 1 ) * max ( 0. dB , 20 log 10 ( \frac{X a v g ( i - 1 )}{X a v g ( i )} ) )$$
where scATH(i) is given by:
float scATH[Ngrp−1]={0.455444335937500,0.930755615234375,0.973083496093750,0.999969482421875,0.908508300781250,0.775665283203125,0.5}.

10. The method of claim 6, wherein analyzing the accumulated weighted deltas versus thresholds comprises analyzing the accumulated weighted deltas versus thresholds according to
$$third bit = \{ \begin{matrix}1 , & {tot}_{incHF} > 4.5 dB \\ 0 , & otherwise\end{matrix}$$
$$fourth bit = \{ \begin{matrix}1 , & {tot}_{{inc}_{LF}} > 4.5 dB \\ 0 , & otherwise\end{matrix}$$
$$fifth bit = \{ \begin{matrix}1 , & {tot}_{{inc}_{LF}} + {tot}_{incHF} > 6. dB \\ 0 , & otherwise\end{matrix} .$$

11. The method of claim 10, wherein determining for each of the third bit, the fourth bit, and the fifth bit of the non_pure_tone_detect, whether the bit is to be assigned the non-initial value or kept at the initial value comprises:
$$for the third bit : assigning the \\ \\ \\ third bit the non - initial value if {tot}_{incHF} > 4.5 dB ;$$
$$and keeping the third bit at the initial value if {tot}_{incHF} \leq 4.5 dB ;$$
$$for the fourth bit : assigning the \\ \\ \\ fourth bit the non - initial value if {tot}_{{inc}_{LF}} > 4.5 dB ;$$
$$and keeping the fourth bit at the initial value if {tot}_{{inc}_{LF}} \leq 4.5 dB ;$$
$$for the fifth bit : assigning the fifth \\ \\ \\ bit the non - initial value if {tot}_{{inc}_{LF}} + {tot}_{incHF} > 6. dB ;$$
$$and keeping the fifth bit at the initial value if {tot}_{{inc}_{LF}} + {tot}_{incHF} \leq 6. dB .$$

12. The method of claim 1, wherein the packet loss concealment creates a reconstructed audio signal to replace an audio signal of a bad frame, the method further comprising:
creating the reconstructed audio signal based on whether or not the valley bins in the FD evolution step are muted; and
forwarding the reconstructed audio signal to a device for playback.

13. A decoder comprising:
a processing circuitry; and
a memory coupled with the processing circuitry, wherein the memory includes instructions that when executed by the processing circuitry causes the decoder to perform operations to determine whether or not to mute valley bins in a frequency domain, FD, evolution step of a packet loss concealment in the decoder, the decoder, the operations comprising:
obtaining an initial number of peaks, n_plocs, and peak locations, plocs, of the audio signal;
if the number of peaks indicated by n_plocs is 1 or 2, performing, using the plocs, a non-pure sinusoidal analysis to determine whether or not the audio signal is a pure sinusoid;
responsive to determining that the audio signal is not a pure sinusoid, not muting the valley bins in the FD evolution step; and
responsive to determining that the audio signal is a pure sinusoid, muting the valley bins in the FD evolution step.

14. The decoder of claim 13, wherein performing the non-pure sinusoidal analysis comprises:
setting a register variable, non_pure_tone_detect, to an initial value;
performing a sinusoidal width analysis;
performing a bin wise dynamics analysis;
performing an envelope band-wise taper-off analysis;
updating the non_pure_tone_detect after each analysis;
responsive to any bits of the non_pure_tone_detect being set to a non-initial value based on analysis results, determining that the audio signal is not a pure sinusoid; and
responsive to no bits of the non_pure_tone_detect being set to a non-initial value based on analysis results, determining that the audio signal is a pure sinusoid.

15. The decoder of claim 14, wherein in performing the sinusoidal width analysis comprises:
determining if there are two peaks identified in the audio signal and the distance between the two peaks is larger than or equal to 250 hertz (Hz); and
responsive to determining that there are two peaks identified in the audio signal and the distance between the two peaks is larger than or equal to 250 Hz, setting a first bit of the non_pure_tone_detect to the non-initial value; and
responsive to determining that there are two peaks identified in the audio signal and the distance between the two peaks is less than 250 Hz, keeping the first bit at the initial value.

16. The decoder of claim 14, wherein performing the bin wise dynamics analysis comprises:
assigning a peak with a largest amplitude to be a center peak;
defining a local analysis range from a low_ind to and including a high_ind;
determining a lowest valley in the local analysis region;
determining whether a local peak-to-valley ratio is below a threshold decibel, dB;
responsive to the local peak-to-valley ratio being below the threshold dB, setting a second bit of the non_pure_tone_detect to the non-initial value; and
responsive to the local peak-to-valley ratio being above the threshold dB, keeping the second bit at the initial value.

17. The decoder of claim 16, wherein the local analysis region is defined according to a first formula for computing the low_ind and a second formula for computing the high_ind, wherein the first formula determines a maximum value between 62.5 and a result computed by multiplying a center peak value by 62.5 and subtracting 312.5 hertz and then divides the maximum value by 62.5 and the second formula determines a minimum value between half of a sampling frequency value minus 62.5 and a result computed by multiplying a center peak value by 62.5 and adding 312.5 Hz, then divides the minimum value by 62.5, and wherein the lowest valley in the local analysis region is established by determining a minimum value from the absolute amplitude values of the bins of the local analysis range; and
wherein the threshold dB is less than 24 dB and the local peak-to-valley region is defined by dividing the absolute value of the center peak by the absolute value of the lowest valley.

18. The decoder of claim 14, wherein performing the envelope band-wise taper-off analysis comprises:
determining which bands the audio signal is occupying;
refining bands for which the audio signal is occupying by analyzing a vicinity of the main lobe to a band border to refine an ind_low and an ind_high;
evaluating amplitude evolution in bands below the ind_low and above the ind_high for consistent tapering off;
analyzing accumulated weighted deltas versus thresholds; and
determining for each of a third bit, a fourth bit, and a fifth bit of the non_pure_tone_detect, whether the bit is to be assigned the non-initial value or kept at the initial value.

19. The decoder of claim 18, wherein determining which band the audio signal is occupying comprises determining which band the audio signal is occupying according to
$$ind\_pre ( b ) = \{ \begin{matrix}b & , plocs [ tone\_ind ] \geq gwlpr ( b + 1 ) , b ∈ 0 … ( Ngrp - 1 ) \\ - 1 & otherwise\end{matrix}$$
$$ind\_low = {arg max}_{b = 0 … ( Ngrp - 1 )} ( ind\_pre ( b ) )$$
$$ind\_high = ind\_low .$$

20. The decoder of claim 18, wherein refining the bands comprises refining the bands according to
$$ind\_low = \{ \begin{matrix} & ind\_high > 1 \\ ind\_high - 1 , & AND \\ & ( plocs [ tone\_ind ] * 62.5 - 250 Hz ) \geq gwlpr ( ind\_high + 1 ) \\ ind\_low , & otherwise\end{matrix}$$
$$and$$
$$ind\_high = \{ \begin{matrix} & ind\_low < ( Ngrp - 1 ) \\ ind\_low + 1 , & AND \\ & ( plocs [ tone\_ind ] * 62.5 + 250 Hz ) \geq gwlpr ( ind\_low + 1 ) \\ ind\_high , & otherwise\end{matrix} .$$

21. The decoder of claim 18, wherein evaluating the amplitude evolution in bands below the ind_low and above the ind_high comprises evaluating the amplitude evolution according to:
$$tot\_inc \_HF = {\sum }_{i = ind \_ high + 1}^{( Ngrp - 1 )} s c A T H ( i ) * max ( 0. dB , 20 log 10 ( \frac{X a v g ( i + 1 )}{X a v g ( i )} ) )$$
$$tot\_inc \_LF = {\sum }_{i = max ( 0 , ind \_ low - 1 )}^{0} s c A T H ( i - 1 ) * max ( 0. dB , 20 log 10 ( \frac{X a v g ( i - 1 )}{X a v g ( i )} ) )$$
where scATH(i) is given by:
float scATH[Ngrp−1]={0.455444335937500,0.930755615234375,0.973083496093750,0.999969482421875,0.908508300781250,0.775665283203125,0.5}.

22. The decoder of claim 18, wherein analyzing the accumulated weighted deltas versus thresholds comprises analyzing the accumulated weighted deltas versus thresholds according to:
$$third bit = \{ \begin{matrix}1 , & {tot}_{incHF} > 4.5 dB \\ 0 , & otherwise\end{matrix}$$
$$fourth bit = \{ \begin{matrix}1 , & {tot}_{{inc}_{LF}} > 4.5 dB \\ 0 , & otherwise\end{matrix}$$
$$fifth bit = \{ \begin{matrix}1 , & {tot}_{{inc}_{LF}} + {tot}_{incHF} > 6. dB \\ 0 , & otherwise\end{matrix} .$$

23. The decoder of claim 22, wherein in determining for each of the third bit, the fourth bit, and the fifth bit of the non_pure_tone_detect, whether the bit is to be assigned the non-initial value or kept at the initial value comprises:
$$for the third bit : assigning the \\ \\ \\ third bit the non - initial value if {tot}_{incHF} > 4.5 dB ;$$
$$and keeping the third bit at the initial value if {tot}_{incHF} \leq 4.5 dB ;$$
$$for the fourth bit : assigning the \\ \\ \\ fourth bit the non - initial value if {tot}_{{inc}_{LF}} > 4.5 dB ;$$
$$and keeping the fourth bit at the initial value if {tot}_{{inc}_{LF}} \leq 4.5 dB ;$$
$$for the fifth bit : assigning the fifth \\ \\ \\ bit the non - initial value if {tot}_{{inc}_{LF}} + {tot}_{incHF} > 6. dB ;$$
$$and keeping the fifth bit at the initial value if {tot}_{{inc}_{LF}} + {tot}_{incHF} \leq 6. dB .$$

24. The decoder of claim 13, wherein the packet loss concealment creates a reconstructed audio signal to replace an audio signal of a bad frame, the operations further comprising:
creating the reconstructed audio signal based on whether or not the valley bins in the FD evolution step are muted; and
forwarding the reconstructed audio signal to a device for playback.

25-27. (canceled)
